(19) United States
(12) Patent Application Publication
(10) Pub. No.: US 2023/0128321 A1
(43) Pub. Date: Apr. 27, 2023

(54) FLUID-DYNAMIC STRUCTURES HAVING PASSIVE DRAG REDUCTION SYSTEMS AND RELATED METHODS

(71) Applicant: The Boeing Company, Chicago, IL (US)

(72) Inventor: Zachary Charles Hoisington, Seal Beach, CA (US)

(21) Appl. No.: 17/508,856

(22) Filed: Oct. 22, 2021

(51) Int. Cl. B64C 21/02

(52) U.S. Cl. CPC B64C 21/025

(57) ABSTRACT

The fluid-dynamic structure comprises a fluid-dynamic exterior having a flow-augmented surface and a passive drag reduction system comprising a flow-repositioning duct having an inlet and an outlet that extend through the fluid-dynamic exterior. Under operative conditions, the passive drag reduction system is configured to direct a captured fluid stream into the inlet, through the flow-repositioning duct, and out of the outlet as a buffering fluid stream that flows along the flow-augmented surface. The inlet and the outlet are conformed and/or positioned such that, under the operative conditions, a total pressure at the inlet is greater than a total pressure at the outlet. The methods comprise flowing a bulk fluid stream across the fluid-dynamic exterior, establishing a pressure differential between the inlet and the outlet, and directing the captured fluid stream into the inlet and out of the outlet to flow along the flow-augmented surface as the buffering fluid stream.

### FIELD

The present disclosure relates to fluid-dynamic structures having passive drag reduction systems and related methods.

### BACKGROUND

A fluid-dynamic structure generally may be utilized to describe any structure that is configured to encounter fluid flow along one or more contact surfaces during operation. Examples of fluid-dynamic structures include aircraft, land vehicles, watercraft, wind turbines, and various components thereof. During operation, a fluid-dynamic structure experiences some degree of drag, or fluid resistance, from the fluid flow that imparts a force opposing relative motion between the fluid-dynamic structure and the fluid flow. Regardless of application, drag usually functions to reduce operative efficiency of a fluid-dynamic structure, and fluid-dynamic structures are therefore most often configured to minimize drag effects. Viscous drag, or parasitic drag, is a particular type of drag that occurs between the fluid flow and the contact surfaces of the fluid-dynamic structure. For many fluid-dynamic structures, viscous drag increases with the square of relative velocity, and laminar flow creates less viscous drag than turbulent flow. Thus, one approach to reducing viscous drag is to shape the fluid-dynamic structure in a manner that encourages the fluid to flow along its exterior in a laminar pattern. However, laminar flow is easily disrupted, for example by protruding features on a contact surface of the fluid-dynamic structure, and maintaining laminar flow along a large portion of the contact surfaces of the fluid-dynamic structure is challenging. For this reason, attempts to reduce viscous drag by encouraging laminar flow often are limited in the enhancement they can provide to operative efficiency. Other approaches for enhancing operative efficiency of fluid-dynamic structures have been developed that utilize powered systems to manipulate fluid flow about the fluid-dynamic structure. However, powered systems generally increase complexity and weight and consume energy, making it difficult to achieve overall operative efficiency benefits. Thus, a need exists for improved systems and methods for reducing drag along fluid-dynamic structures.

### SUMMARY

Fluid-dynamic structures and methods of passively reducing drag on fluid-dynamic structures are disclosed herein. The fluid-dynamic structure comprises a passive drag reduction system and a fluid-dynamic exterior that comprises a flow-augmented surface. The passive drag reduction system comprises a flow-repositioning duct that extends within a structural interior of the fluid-dynamic structure and comprises an inlet and an outlet. The inlet and the outlet extend through the fluid-dynamic exterior spaced apart from one another, and at least the outlet is positioned directly adjacent to the flow-augmented surface. Under operative conditions, in which a bulk fluid stream flows across the fluid-dynamic exterior, the passive drag reduction system is configured to passively direct a captured fluid stream into the inlet, through the flow-repositioning duct, and exhaust the captured fluid stream through the outlet as a buffering fluid stream. The outlet is configured to inject the buffering fluid stream between the bulk fluid stream and the flow-augmented surface and direct the buffering fluid stream to flow along the flow-augmented surface. The inlet and the outlet are conformed such that, under the operative conditions, an inlet total pressure established at the inlet is greater than an outlet total pressure established at the outlet. Additionally or alternatively, the inlet and the outlet are respectively positioned along the fluid-dynamic exterior such that, under the operative conditions, the inlet total pressure is greater than the outlet total pressure.

The methods comprise flowing the bulk fluid stream across the fluid-dynamic exterior, during the flowing, establishing a pressure differential between the inlet and the outlet such that the inlet total pressure is greater than the outlet total pressure, passively directing the captured fluid stream into the inlet and through the flow-repositioning duct, passively exhausting the captured fluid stream through the outlet as the buffering fluid stream, and guiding the buffering fluid stream, with the outlet, to flow along the flow-augmented surface and between the bulk fluid stream and the flow-augmented surface, where the passively directing and the passively exhausting are driven by the pressure differential.

### BRIEF DESCRIPTION OF THE DRAWINGS

FIG. 1 is an illustration of examples of aircraft including at least one passive drag reduction system according to the present disclosure.

FIG. 2 is an illustration of examples of watercraft including at least one passive drag reduction system according to the present disclosure.

FIG. 3 is an illustration of examples of wind turbines including at least one passive drag reduction system according to the present disclosure.

FIG. 4 is a schematic cross-sectional view of examples of fluid-dynamic structures comprising passive drag reduction systems according to the present disclosure.

FIG. 5 is a schematic plan view of examples of fluid-dynamic structures comprising passive drag reduction systems according to the present disclosure.

FIG. 6 is a schematic cross-sectional view showing examples of airfoils comprising passive drag reduction systems according to the present disclosure.

FIG. 7 is an illustration of an example airfoil having an example passive drag reduction system according to the present disclosure showing the example airfoil under operative conditions.

FIG. 8 is a partial view of the example airfoil of FIG. 7.

FIG. 9 is another partial view of the example airfoil of FIG. 7.

FIG. 10 is a schematic cross-sectional view showing an example airfoil having a passive drag reduction system that comprises two inlets and two outlets according to the present disclosure.

FIG. 11 is a flowchart schematically representing examples of methods of passively reducing drag on a fluid-dynamic structure according to the present disclosure.

### DETAILED DISCLOSURE

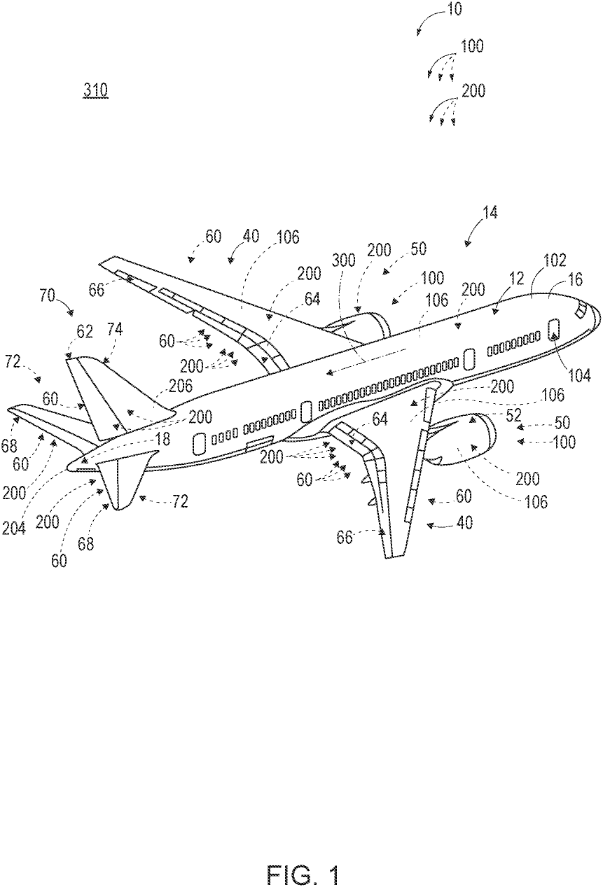

FIGS. 1-11 illustrate examples of fluid-dynamic structures 100 comprising passive drag reduction systems 200, aircraft 10 comprising at least one passive drag reduction system 200, watercraft 90 comprising at least one passive drag reduction system 200, wind turbines 80 comprising at least one passive drag reduction system 200, airfoils 150 comprising passive drag reduction systems 200, and methods 500 of passively reducing drag on fluid-dynamic structures 100 utilizing passive drag reduction systems 200 according to the present disclosure. Elements that serve a similar, or at least substantially similar, purpose are labelled with like numbers in each of FIGS. 1-11, and these elements may not be discussed in detail herein with reference to each of FIGS. 1-11. Similarly, all elements may not be labeled in each of FIGS. 1-11, but reference numerals associated therewith may be utilized herein for consistency. Elements, components, and/or features that are discussed herein with reference to one or more of FIGS. 1-11 may be included in and/or utilized with any of FIGS. 1-11 without departing from the scope of the present disclosure.

Generally, in the figures, elements that are likely to be included in a given example are illustrated in solid lines, while elements that are optional to a given example are illustrated in dashed lines. However, elements that are illustrated in solid lines are not essential to all examples of the present disclosure, and an element shown in solid lines may be omitted from a particular example without departing from the scope of the present disclosure. Also in the figures, dot-dash lines are utilized to indicate various virtual and/or environmental features, such as directions, dimensions, fluid flows, etc., that are defined by and/or interact with the illustrated embodiment.

FIGS. 1-3 illustrate examples of fluid-dynamic structures 100 that comprise at least one passive drag reduction system 200, and optionally a plurality of passive drag reduction systems 200, according to the present disclosure.

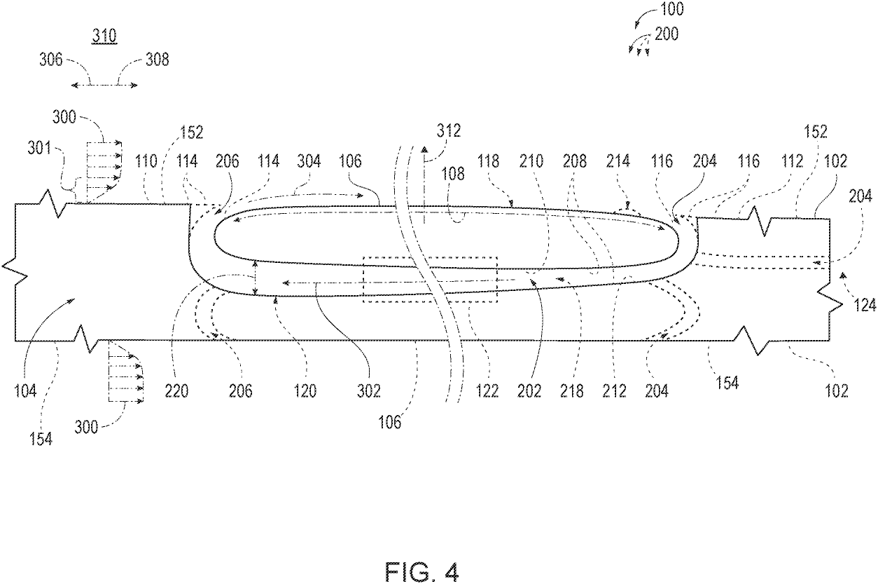

FIG. 1 is an illustration of an example aircraft 10 that comprises at least one, and optionally a plurality of, passive drag reduction systems 200, according to the present disclosure. More specific examples of passive drag reduction systems 200 are illustrated and discussed herein with reference to FIGS. 4-8.

Aircraft 10 comprises a fluid-dynamic structure 100 having a fluid-dynamic exterior 102 that separates a structural interior 104 of fluid-dynamic structure 100 from an exterior region 310 that is exterior to fluid-dynamic structure 100. Typically, exterior region 310 is the air that surrounds aircraft 10. Aircraft 10 comprises an airframe 14 and a skin 16 that is supported by, and surrounds, airframe 14. In some examples, airframe 14 forms at least a portion of fluid-dynamic structure 100, and skin 16 comprises at least a portion of fluid-dynamic exterior 102.

As shown in FIG. 1, aircraft 10 comprises a fuselage 12 and one or more wings 40 that are supported by, and extend from, fuselage 12. In some examples, aircraft 10 comprises an empennage 70 attached to and/or extending from fuselage 12. In some examples, empennage 70 comprises at least one horizontal stabilizer 72 and/or at least one vertical stabilizer 74. When included in aircraft 10, fuselage 12, wing(s) 40, and empennage 70 each define a portion of airframe 14 and comprise a portion of skin 16 that surrounds the respective portion of airframe 14. In other words, fuselage 12, wing(s) 40, and empennage 70 each may form a portion of fluid-dynamic structure 100 and comprise a respective portion of fluid-dynamic exterior 102. With this in mind, fluid-dynamic exterior 102 may comprise a plurality of surfaces defined by the various components of aircraft 10, and structural interior 104 of fluid-dynamic structure 100 may comprise a plurality of regions respectively defined by the various components of aircraft 10. Additionally or alternatively, in some examples, aircraft 10 comprises a plurality of fluid-dynamic structures 100. In such examples, fuselage 12, wing(s) 40, and/or empennage 70 each may comprise a respective fluid-dynamic structure 100 having a respective fluid-dynamic exterior 102.

In some examples, aircraft 10 comprises one or more engines 50 operably attached to airframe 14, such as to a wing 40 thereof. In such examples, each engine 50 may form a portion of fluid-dynamic structure 100 of aircraft 10 or each engine 50 may comprise a respective fluid-dynamic structure 100. In some examples, wings 40 and/or empennage 70 comprise one or more flight control surfaces 60, examples of which include rudders 62, flaps 64, ailerons 66, and/or elevators 68. In such examples, any given flight control surface 60 may define a portion of fluid-dynamic structure 100 of aircraft 10 or any given flight control surface 60 may define a respective fluid-dynamic structure 100.

Under operative conditions, such as when aircraft 10 is in flight and/or cruising at altitude, a bulk fluid stream 300, or more specifically an airstream, flows across one or more fluid-dynamic exteriors 102 of aircraft 10. As discussed in more detail herein with reference to FIGS. 4-8, passive drag reduction systems 200, according to the present disclosure, comprise a flow-repositioning duct that extends within fluid-dynamic exterior 102 of fluid-dynamic structure 100. The flow-repositioning duct comprises an inlet and an outlet that extend through fluid-dynamic exterior 102 spaced apart from one another. Under the operative conditions, in which bulk fluid stream 300 flows across the respective fluid-dynamic exterior 102, passive drag reduction system 200 is configured to passively direct a captured fluid stream, or specifically a captured airstream in the case of aircraft 10, into the inlet, through the flow-repositioning duct, and exhaust the captured fluid stream through the outlet as a buffering fluid stream. The outlet is configured to guide the buffering fluid stream to flow across a flow-augmented surface comprised in fluid-dynamic exterior 102, such that the buffering fluid stream flows between the flow-augmented surface and the bulk fluid stream. As discussed in more detail herein, the buffering fluid stream generated by passive drag reduction system 200 reduces viscous drag applied to flow-augmented surface 106 by the bulk fluid stream 300. In other words, passive drag reduction system 200 is configured to reduce viscous drag on aircraft 10 under operative conditions.

Stated in slightly different terms, aircraft 10 may be described as comprising at least one, and optionally a plurality of, flow-augmented surface(s) 106, with each flow-augmented surface 106 being defined along a region of a fluid-dynamic exterior 102 of aircraft 10 corresponding to the position of the outlet of a respective passive drag reduction system 200.

Passive drag reduction system 200 may be comprised in any suitable region, portion, and/or component of aircraft 10. In some examples, a given passive drag reduction system 200 is comprised in, and extends between, two or more regions, portions, and/or components of aircraft 10. In such examples, the two or more regions, portions, and/or components may be described as being comprised in a single or common fluid-dynamic structure 100 of aircraft 10.

In some examples, fuselage 12 comprises at least one passive drag reduction system 200, and skin 16 thereof comprises at least one corresponding flow-augmented surface 106. In some examples, fuselage 12 comprises a protrusion, for an antenna or fairing, and passive drag reduction system 200 is positioned to flow the buffering fluid stream along skin 16 of fuselage 12 about the protrusion, such that the protrusion is comprised in or extends within the corresponding flow-augmented surface 106. In some examples, at least one flight control surface 60 comprises a respective passive drag reduction system 200. As more specific examples, one or more of rudders 62, flaps 64, ailerons 66, and/or elevators 68 each may comprise a respective passive drag reduction system 200.

In some examples, one or more wings 40 each comprise one or more respective passive drag reduction systems 200. In some examples, passive drag reduction system 200 is defined in the fixed portion of wing 40, which as utilized herein, refers to the main body of wing 40 and does not comprise any flight control surfaces 60 associated with wing 40. In such examples, passive drag reduction system 200 may be configured to form flow-augmented surface 106 along an upper skin or lower skin of the wing. In some examples, a given wing 40 comprises at least one passive drag reduction system 200 in a fixed portion of wing 40 and at least one passive drag reduction system 200 in one or more of the associated flight control surfaces 60.

In some examples, at least one engine 50 comprises a respective passive drag reduction system 200. As a more specific example, engine 50 may comprise an engine nacelle, or fan cowl, 52 that surrounds engine 50. In some examples, engine nacelle 52 comprises an airfoil that is revolved around the engine centerline. In some examples, passive drag reduction system 200 is comprised in engine nacelle 52 of engine 50. In such examples, passive drag reduction system 200 is configured to exhaust the buffering fluid stream along an exterior of engine nacelle 52, or a surface of engine nacelle 52 that faces exterior region 310. In other words, passive drag reduction system 200 may form flow-augmented surface 106 along the exterior of engine nacelle 52.

In some examples, empennage 70 comprises one or more passive drag reduction systems 200. In more specific examples, horizontal stabilizer 72 comprises at least one passive drag reduction system 200 and/or vertical stabilizer 74 comprises at least one passive drag reduction system 200. Additionally or alternatively, in some examples, at least one flight control surface 60 of empennage 70 comprises a passive drag reduction system 200. In some more specific examples, one or more passive drag reduction systems 200 are comprised in one or more elevators 68 of horizontal stabilizer 72 and/or one or more passive drag reduction systems 200 are comprised in one or more rudders 62 of vertical stabilizer 74.

As mentioned, in some examples, passive drag reduction system 200 extends between discrete portions, regions, or components of aircraft 10. In such examples, the inlet of passive drag reduction system 200 draws captured airflow from, or from adjacent to, a surface of fluid-dynamic exterior 102 that is spaced away from the surface of fluid-dynamic exterior 102 through which the outlet of passive drag reduction system 200 extends. In such examples, passive drag reduction system 200 is configured to reposition airflow between spaced-apart regions or surfaces of fluid-dynamic exterior 102. In a more specific example, fuselage 12 comprises a tail cone 18 that extends aft of at least a portion of empennage 70, and the inlet 204 of passive drag reduction system 200 is disposed along tail cone 18. The outlet 206 of passive drag reduction system 200 may be disposed along or adjacent to a leading edge of horizontal stabilizer 72 or vertical stabilizer 74. The flow-repositioning duct of passive drag reduction system 200 extends from inlet 204, through portions of fuselage 12 and empennage 70, and to outlet 206. In such examples, passive drag reduction system 200 is configured to draw the captured fluid stream from fuselage 12 and exhaust the buffering fluid stream along the leading edge of horizontal stabilizer 72 or vertical stabilizer 74.

Aircraft 10 may comprise any suitable type of aircraft, with examples including a private aircraft, a commercial aircraft, a passenger aircraft, a military aircraft, a jetliner, an autonomous aircraft, a wide-body aircraft, and/or a narrow body aircraft. While FIG. 1 illustrates examples in which aircraft 10 is a fixed wing aircraft, passive drag reduction systems 200 also may be comprised in and/or utilized with other types of aircraft, with illustrative non-exclusive examples of other types of aircraft including rotorcraft, helicopters, tiltwing aircraft, tiltrotor aircraft, glider aircraft, missiles, rockets, rocket propulsion systems, and/or spacecraft.

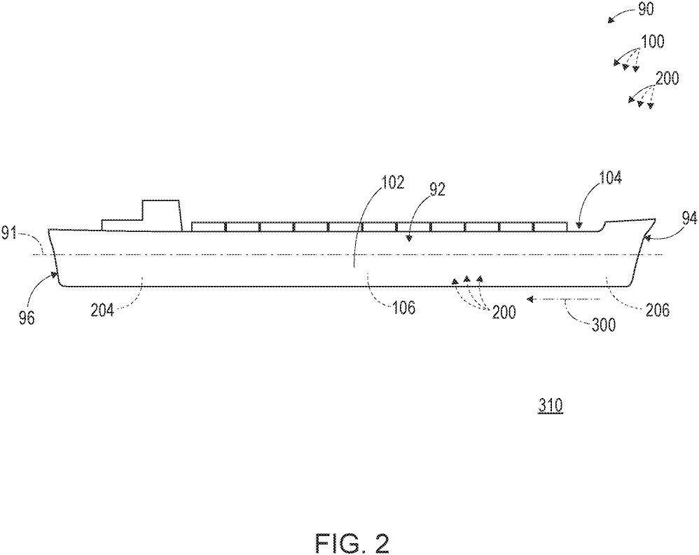

Turning to FIG. 2, illustrated therein is an example watercraft 90 that comprises at least one passive drag reduction system 200 according to the present disclosure. As shown in FIG. 2, watercraft 90 comprises a hull 92 that extends below a waterline 91 during operative use of watercraft 90 and partitions structural interior 104 of watercraft 90 from exterior region 310, which comprises water. Accordingly, hull 92 defines at least a portion of fluid-dynamic exterior 102 of watercraft 90. Hull 92 comprises a bow 94 that defines the foremost part of hull 92 and a stern 96 that defines an aft-most portion of hull 92.

In some examples, watercraft 90 comprises at least one passive drag reduction system 200 that is comprised in hull 92. In such examples, with inlet 204 and outlet 206 of passive drag reduction system extend through hull 92 and the flow-repositioning duct of passive drag reduction system 200 extends within hull 92. Typically, inlet 204 and outlet 206 of passive drag reduction system 200 are spaced apart from one another along the length of hull 92, where inlet 204 may be positioned closer to stern 96 than outlet 206. Under operative conditions, a bulk fluid stream 300, which comprises water, flows across hull 92 generally in a direction extending towards stern 96 from bow 94. Often, bulk fluid stream 300 imparts viscous drag as it flows along hull 92.

Under the operative conditions, passive drag reduction system 200 is configured to draw the captured fluid stream, which comprises water, into inlet 204, and exhaust captured fluid stream 302 as the buffering fluid stream 304 from outlet 206 to flow along fluid-dynamic exterior 102 of hull 92. Specifically, outlet 206 is configured to exhaust the buffering fluid stream to flow along a flow-augmented surface 106 of hull 92 and between flow-augmented surface 106 and bulk fluid stream 300. As discussed in more detail herein, the buffering fluid stream thereby reduces viscous drag along the flow-augmented surface 106 of hull 92.

In some examples, watercraft 90 comprises a plurality of passive drag reduction systems 200 incorporated in hull 92. In some such examples, two or more passive drag reduction systems 200 are disposed in parallel, or in a side-by-side relationship, along the length of hull 92. Additionally or alternatively, in some examples two or more passive drag reduction systems 200 are disposed in a series, or in an end-to end relationship, along the length of hull 92.

Passive drag reduction systems 200 may be comprised in any suitable type of watercraft 90. While FIG. 2 illustrates examples in which watercraft 90 is a cargo ship, passive drag reduction systems 200 additionally or alternatively may be comprised in passenger ships, ferries, naval ships, recreational ships, hydrofoil ships, submarines, fishing boats, deck boats, catamaran boats, yachts, sail boats, dinghy boats, canoes, kayaks, paddleboards, and/or surfboards.

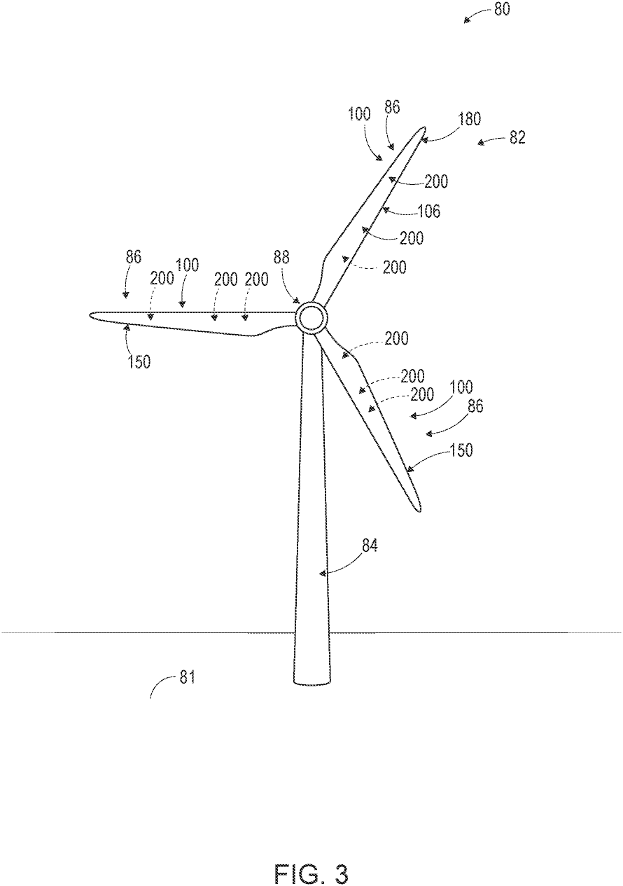

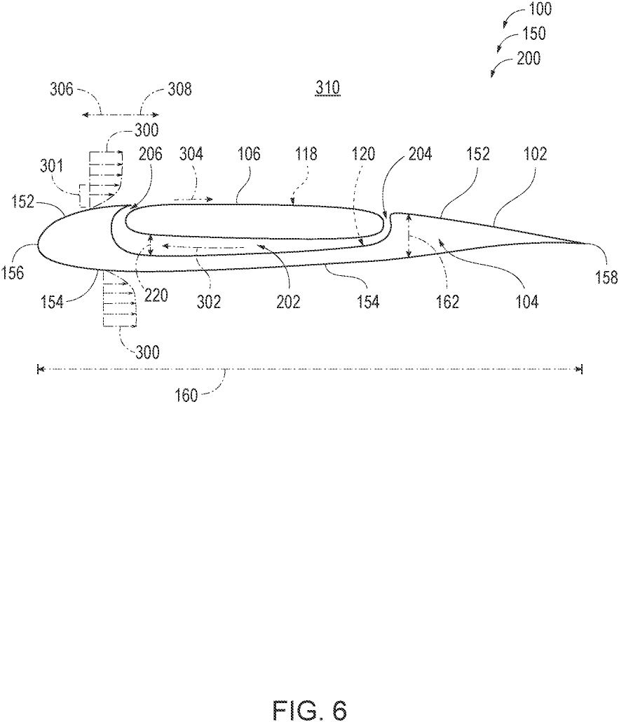

FIG. 3 illustrates an example of a wind turbine 80 that comprises at least one passive drag reduction system 200 according to the present disclosure. As shown in FIG. 3, wind turbine 80 comprises a rotor assembly 82 and a tower 84 that supports rotor assembly 82 spaced above a ground surface 81. Rotor assembly 82 comprises a plurality of rotor blades 86 and a rotor hub 88 that supports rotor blades 86. Each rotor blade 86 may be regarded as a fluid-dynamic structure 100 having a respective fluid-dynamic exterior 102. At least one, and optionally each, rotor blade 86 may comprise at least one respective passive drag reduction system 200. Each rotor blade 86 may be, or be formed as, an airfoil 150. Examples of passive drag reduction systems 200 incorporated into airfoils 150 according to the present disclosure are illustrated and discussed in more detail herein with reference to FIGS. 6-10. In other words, each rotor blade 86 may be an airfoil 150 according to the examples of FIGS. 6-8 and/or may incorporate passive drag reduction system(s) 200 according to the examples of FIGS. 6-8.

Passive drag reduction systems 200 according to the present disclosure also are not limited to use in the examples of fluid-dynamic structures 100 presented in FIGS. 1-3, and passive drag reduction systems 200 generally may be comprised in and/or utilized with any fluid-dynamic structure that may experience viscous drag under operative conditions. Additional or alternative examples of suitable fluid-dynamic structures 100 in which passive drag reduction systems 200 according to the present disclosure may be comprised or utilized in conjunction with ground transportation vehicles, cars, trains, fluid-moving devices, fans, and/or impellers.

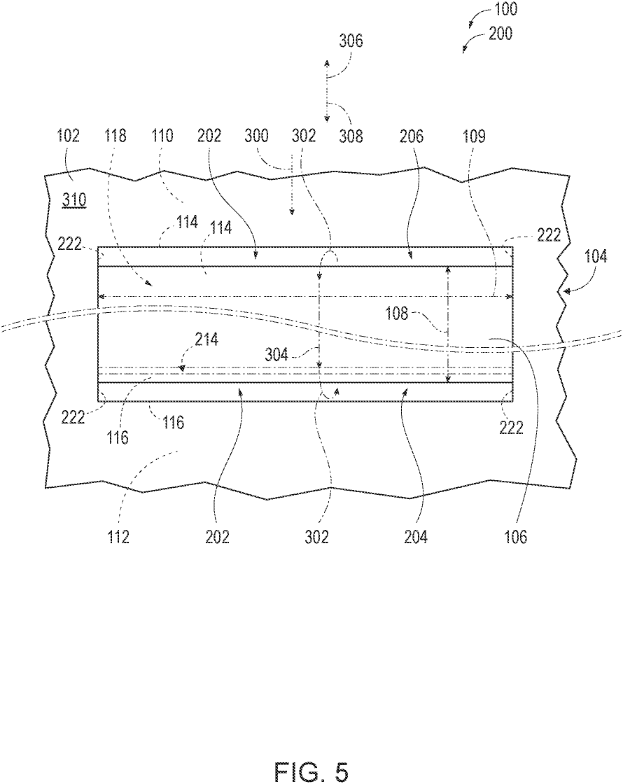

FIGS. 4 and 5 schematically illustrate examples of fluid-dynamic structures 100 comprising passive drag reduction systems 200 according to the present disclosure. Specifically, FIG. 4 is a schematic cross-sectional view of fluid-dynamic structure 100, and FIG. 5 is a schematic plan view of fluid-dynamic structure 100. With reference to FIGS. 4 and 5, fluid-dynamic structure 100 comprises a fluid-dynamic exterior 102 that separates a structural interior 104 of fluid-dynamic structure 100 from an exterior region 310 that is exterior to fluid-dynamic structure 100. Fluid-dynamic exterior 102 comprises a flow-augmented surface 106. Examples of fluid-dynamic structures 100 are illustrated and discussed herein with reference to FIGS. 1-3 and 6-8.

Fluid-dynamic structure 100 also comprises at least one passive drag reduction system 200, and optionally a plurality of passive drag reduction systems 200. Passive drag reduction system 200 comprises a flow-repositioning duct 202 that extends within structural interior 104 of fluid-dynamic structure 100. Flow-repositioning duct 202 comprises an inlet 204 and an outlet 206 that extend through fluid-dynamic exterior 102. Inlet 204 and outlet 206 are spaced apart from one another along fluid-dynamic exterior 102, and at least outlet 206 is positioned directly adjacent to flow-augmented surface 106. In some examples, inlet 204 also is positioned directly adjacent to flow-augmented surface 106.

Under operative conditions, in which a bulk fluid stream 300 of fluid flows across fluid-dynamic exterior 102, passive drag reduction system 200 is configured to passively direct a captured fluid stream 302 into inlet 204, through flow-repositioning duct 202, and exhaust captured fluid stream 302 through outlet 206 as a buffering fluid stream 304. Outlet 206 is configured to inject buffering fluid stream 304 between bulk fluid stream 300 and flow-augmented surface 106 and direct buffering fluid stream 304 to flow along flow-augmented surface 106. In other words, outlet 206 may be configured to direct buffering fluid stream 304 to fluidly partition flow-augmented surface 106 from bulk fluid stream 300.

The term “passively,” when utilized herein to describe functions performed by passive drag reduction system 200, is defined herein to mean without requiring the use of, independently of, or in the absence of, an external or active power source. Thus, passive drag reduction system 200 being configured to “passively” direct captured fluid stream 302 into inlet 204, through flow-repositioning duct 202, and exhaust captured fluid stream 302 through outlet, means that passive drag reduction system 200 is configured to perform these functions without utilizing, in the absence of, or without needing, an external power source, such as a compressor, a fan, a pump, or a turbine. While fluid-dynamic structure 100 may comprise and/or be associated with one or more powered elements that facilitate relative movement between fluid-dynamic structure 100 and bulk fluid stream 300, when the operative conditions are established, flow-repositioning duct 202 is configured to passively direct captured fluid stream 302 into inlet 204, through flow-repositioning duct 202, and exhaust captured fluid stream 302 through outlet 206 without needing an additional power source to perform this function.

In view of the above, passive drag reduction system 200 is configured such that, under the operative conditions, a total pressure differential is established naturally between inlet 204 and outlet 206, with this total pressure differential at least in part facilitating the passive movement of captured fluid stream 302 by passive drag reduction system 200. More specifically, inlet 204 and outlet 206 are respectively conformed such that, under the operative conditions, an inlet total pressure established at inlet 204 is greater than an outlet total pressure established at the outlet 206. As defined herein, inlet 204 and outlet 206 being “respectively conformed” in this contexts refers to inlet 204 and/or outlet 206 being dimensioned, shaped, and/or oriented such that the inlet total pressure at inlet 204 is greater than the outlet total pressure at the outlet 206 during the operative conditions.

Additionally or alternatively, inlet 204 and outlet 206 respectively positioned along fluid-dynamic exterior 102 such that, under the operative conditions, the inlet total pressure established at inlet 204 is greater than the outlet total pressure established at outlet 206. In some examples, this comprises inlet 204 and outlet 206 being selectively positioned along fluid-dynamic exterior 102 at locations in which a total pressure of bulk fluid stream 300 is greater along the location of inlet 204 than along the location of outlet 206.

As defined herein, the total pressure of a given fluid stream or region of fluid refers to the combined sum of the static pressure and the dynamic pressure of the given fluid stream or region of fluid. The inlet total pressure is specifically defined herein as the average total pressure of captured fluid stream 302 entering inlet 204, and the outlet total pressure is specifically defined herein as the average total pressure of captured fluid stream 302 exiting flow-repositioning duct 202 through outlet 206. Stating the above in slightly different terms, inlet 204 and outlet 206 may be respectively conformed and/or positioned such that, under operative conditions, pressure forces established between inlet 204 and outlet 206 drive the flow of captured fluid stream 302 through flow-repositioning duct 202. In some examples, inlet 204 and outlet 206 are respectively conformed and/or positioned along fluid-dynamic exterior 102 such that, under operative conditions, an inlet static pressure established at inlet 204 is greater than an outlet static pressure established at outlet 206. Likewise, the inlet static pressure may be defined as the average static pressure of captured fluid stream 302 entering inlet 204, and the outlet static pressure may be defined as the average static pressure of captured fluid stream 302 exiting flow-repositioning duct 202 through outlet 206. In some examples, the inlet total pressure is established, at least in part, by the flow of captured fluid stream 302 through inlet 204, and the outlet total pressure is established, at least in part, by the flow of captured fluid stream through outlet 206.

Passive drag reduction system 200 may be configured to reduce drag along fluid-dynamic exterior 102 as discussed herein under a broad range of operative conditions. As defined herein, the “operative conditions” may be established when the flow of bulk fluid stream 300 relative to fluid-dynamic exterior 102 is stable, and at least the portion of bulk fluid stream 300 that is not in immediate contact with fluid-dynamic exterior 102 moves relative to fluid-dynamic exterior 102 within a range of typical velocities for the particular fluid-dynamic structure 100. As an example, when fluid-dynamic structure 100 is comprised in an aircraft, such as the example aircraft 10 of FIG. 1, the operative conditions may be established when aircraft 10 is flying under cruising conditions, within a range of typical cruising altitudes, and/or within a range of typical cruising velocities. As an example, typical airliners cruise at altitudes of 9,000-13,000 meters (30,000-42,000 feet) and at velocities of 880-926 kilometers per hour (475-500 knots; 547-575 miles per hour).

As discussed herein, fluid-dynamic structure 100 may be any suitable type of fluid-dynamic structure 100 and/or configured to interact with any suitable type of bulk fluid stream 300. For examples in which fluid-dynamic structure 100 is configured to interact with a gaseous bulk fluid stream 300 and/or in which bulk fluid stream 300 comprises air as a primary component, fluid-dynamic structure 100 additionally or alternatively may be referred to as an aerodynamic structure, and fluid-dynamic exterior 102 additionally or alternatively may be referred to as aerodynamic exterior.

Also under the operative conditions, bulk fluid stream 300 may be described as moving, at least on average, in a downstream direction 308 relative to fluid-dynamic exterior 102 as it flows along fluid-dynamic exterior 102. Thus, downstream direction 308 is defined herein as a direction that is aligned with the direction of the flow of bulk fluid stream 300 at a given location relative to fluid-dynamic exterior 102, and an upstream direction 306 is defined herein as a direction that is opposed to the direction of the flow of bulk fluid stream 300 at a given location relative to fluid-dynamic exterior 102. As shown in FIGS. 4 and 5, outlet 206 typically is positioned in upstream direction 306 of flow-augmented surface 106. In this way, buffering fluid stream 304 may flow along with bulk fluid stream 300 in downstream direction 308 upon being exhausted onto flow-augmented surface 106 by outlet 206.

Buffering fluid stream 304 may reduce viscous drag applied to flow-augmented surface 106 by bulk fluid stream 300. In other words, buffering fluid stream 304 may apply less viscous drag to flow-augmented surface 106 than would bulk fluid stream 300 if passive drag reduction system 200 were not present and/or not exhausting buffering fluid stream 304 onto flow-augmented surface 106. Stated another way, under operative conditions, a total viscous drag along fluid-dynamic exterior 102 of fluid-dynamic structure 100 is less than a total viscous drag, under identical operative conditions, on fluid-dynamic exterior 102 of an otherwise equivalent fluid-dynamic structure that does not comprise passive drag reduction system 200.

In particular, bulk fluid stream 300 comprises a surface band 301, which is the layer of bulk fluid stream 300 that flows in the immediate vicinity of fluid-dynamic exterior 102 and is at least in part responsible for the viscous drag applied to fluid-dynamic exterior 102 by bulk fluid stream 300. Surface band 301 comprises a boundary layer, which is the portion of surface band 301 that flows closest to fluid-dynamic exterior 102. In some examples, the thickness of the boundary layer only forms a small percentage of the total thickness of surface band 301. Surface band 301 flows along fluid-dynamic exterior 102 with an average surface band velocity, and at least generally speaking, the viscous drag applied to fluid-dynamic exterior 102 by bulk fluid stream 300 increases with the average surface band velocity. As discussed herein, the average velocity of a particular fluid stream refers to the average velocity of the particular fluid stream taken across a cross-section of the fluid stream normal to the flow-augmented surface 106. In some examples, passive drag reduction system 200 is configured to reduce viscous drag on flow-augmented surface 106 by exhausting buffering fluid stream 304 to flow along flow-augmented surface 106 at an average buffering fluid stream velocity that is less than the average surface band velocity of a surface band that otherwise would flow along flow-augmented surface 106 under operative conditions, absent passive drag reduction system 200 and/or buffering fluid stream 304. In this example, the average surface band velocity and the average buffering stream velocity are measured at equivalent thicknesses, or up to equivalent heights from fluid-dynamic exterior 102. In other words, buffering fluid stream 304 may be described as buffering flow-augmented surface 106 from the viscous drag effects of surface band 301. Stated yet another way, the average buffering fluid stream velocity of buffering fluid stream 304 along flow-augmented surface 106 may be less than the average surface band velocity of a surface band 301 of the same thickness that flows along a region of fluid-dynamic exterior 102 corresponding to flow-augmented 106 surface of an otherwise equivalent fluid-dynamic structure that does not comprise passive drag reduction system 200.

In some examples, the average buffering fluid stream velocity of buffering fluid stream 304 is less than the average surface band velocity of surface band 301, as measured to the same thickness of buffering fluid stream 304, along fluid-dynamic exterior 102 directly adjacent to, and in upstream direction 306 of, outlet 206. In some such examples, under operative conditions, the viscous drag along flow-augmented surface 106 is less than the viscous drag on one or more adjacent regions of fluid-dynamic exterior 102.

In some examples, passive drag reduction system 200 is configured to guide buffering fluid stream 304 to remain attached to flow-augmented surface 106, and/or to fluidly partition flow-augmented surface 106 from bulk fluid stream 300, along at least a portion of a length 108 of flow-augmented surface 106. As defined herein, length 108 of flow-augmented surface 106 is measured from outlet 206, along downstream direction 308, to the terminus of flow-augmented surface 106, which may be defined by inlet 204 or a trailing edge of fluid-dynamic exterior 102. In some examples, the reduction in viscous drag afforded by passive drag reduction system 200 increases with the portion of length 108 of flow-augmented surface 106 along which buffering fluid stream 304 remains attached and/or fluidly partitions flow-augmented surface 106 from bulk fluid stream 300. In some examples, passive drag reduction system 200 is configured such that buffering fluid stream 304 remains attached to flow-augmented surface 106 and/or fluidly partitions flow-augmented surface 106 from bulk fluid stream 300 along at least a threshold fraction of length 108 of flow-augmented surface 106. Examples of this threshold fraction include at least 20 percent (%), at least 30%, at least 40%, at least 50%, at least 60%, at least 70%, at least 80%, at least 85%, at least 90%, at most 50%, at most 60%, at most 70%, at most 80%, at most 85%, at most 90%, at most 95%, at most 99%, and/or at most 100%.

As perhaps best seen in FIG. 5, flow-augmented surface 106 defines a width 109 that is measured normal to length 108 of flow-augmented surface 106. In some examples, outlet 206 extends along at least a substantial portion of width 109 of flow-augmented surface 106. In some examples, inlet 204 extends along at least a substantial portion of width 109 of flow-augmented surface 106. In some such examples, outlet 206 is configured to provide buffering fluid stream 304 along at least the substantial portion of width 109 of flow-augmented surface 106. For example, when fluid-dynamic structure 100 is a flight control surface, such as any of the flight control surfaces 60 discussed herein with reference to FIG. 1, width 109 of flow-augmented surface 106 may correspond to the span of flight control surface 60. As another example, when the fluid-dynamic structure 100 is an engine nacelle, such as engine nacelle 52 discussed herein with reference to FIG. 1, width 109 of flow-augmented surface 106 may be at least a portion of, or at least a substantial portion of, the external circumference of engine nacelle 52.

Inlet 204 and outlet 206 may extend through any suitable respective portions of fluid-dynamic exterior 102. Generally speaking, outlet 206 is disposed directly adjacent to, and in upstream direction 306 of, the region of flow-augmented surface 106 along which viscous drag reduction is desired. In some examples, inlet 204 is disposed along fluid-dynamic exterior 102 at a location where the total pressure of bulk fluid stream 300 is greater than the total pressure of bulk fluid stream 300 along outlet 206. As such, in some examples inlet 204 and outlet 206 extend through regions of fluid-dynamic exterior 102 that extend at least substantially parallel to one another and/or at least generally aligned with one another. In other examples, inlet 204 and outlet 206 extend through regions of fluid-dynamic exterior 102 that do not extend at least substantially parallel to one another and/or that define discrete or transverse surfaces. For example, and as shown optionally in dashed lines in FIG. 4, inlet 204 may extend through a trailing region 124 of fluid-dynamic structure 100, while outlet 206 may extend through an upper or longitudinal surface of fluid-dynamic exterior 102 that extends transverse to trailing region 124.

The captured fluid stream 302 may be drawn from one or more fluid streams that flow exterior to inlet 204. In some examples, at least a portion of, and optionally the entirety of, captured fluid stream 302 is drawn from bulk fluid stream 300. This may occur for examples in which inlet 204 and outlet 206 are positioned along discrete surfaces of fluid-dynamic exterior 102 and/or for examples in which inlet 204 is positioned along trailing region 124 of fluid-dynamic exterior 102. In some such examples, passive drag reduction system 200 is described as repositioning the portion of bulk fluid stream 300 that is drawn as captured fluid stream 302. A more specific example of such a configuration of passive drag reduction system 200 is illustrated and discussed herein with reference to FIG. 1, where inlet 204 is disposed along the tail cone 18 of fuselage 12, and outlet 206 is configured to provide buffering fluid stream 304 to the leading edge of horizontal stabilizer 72 or vertical stabilizer 74.

As shown in FIG. 4, bulk fluid stream 300 comprises a surface band 301 that flows directly adjacent to fluid-dynamic exterior 102. Thus, in some examples, at least a portion of captured fluid stream 302 drawn from inlet 204 is from surface band 301. In some examples, surface band 301 flows in a turbulent regime, while a freestream portion of bulk fluid stream 300 that flows exterior of surface band 301 flows in a laminar, or at least quasi-laminar regime. In some such examples, passive drag reduction system 200 is configured to draw and/or reposition turbulent flow from bulk fluid stream 300 and through flow-repositioning duct 202.

Additionally or alternatively, in some examples, at least a portion of captured fluid stream 302 is drawn from buffering fluid stream 304. In some such examples, passive drag reduction system 200 is described as recycling at least a portion of buffering fluid stream 304. In some examples, inlet 204 is disposed along fluid-dynamic exterior 102 in downstream direction 308 of outlet 206. In such examples, and under the operative conditions, flow-repositioning duct 202 is configured to guide captured fluid stream 302 at least partially along upstream direction 306 from inlet 204 to outlet 206. In some examples, outlet 206 is positioned in upstream direction 306 of flow-augmented surface 106, and inlet 204 is positioned directly adjacent to, and in downstream direction 308 of, flow-augmented surface 106. In some such examples, flow-augmented surface 106 is defined and/or extends between inlet 204 and outlet 206. In some such examples, inlet 204 is configured to draw at least a portion of buffering fluid stream 304 from flow-augmented surface 106. In some examples, inlet 204 is configured to draw, from flow-augmented surface 106, a threshold fraction of buffering fluid stream 304 that is exhausted onto flow-augmented surface 106 by outlet 206. Examples of this threshold fraction include between 0% and 30%, at least 30%, at least 40%, at least 50%, at least 60%, at least 70%, at least 80%, at least 85%, at least 90%, at most 50%, at most 60%, at most 70%, at most 80%, at most 85%, at most 90%, at most 95%, at most 99%, and/or at most 100%.

In some examples, the inlet total pressure established at inlet 204 is, at least in part, defined by the total pressure of buffering fluid stream 302 at inlet 204. In some examples, shear forces applied to buffering fluid stream 302 and/or mixing of buffering fluid stream 302 with bulk fluid stream 300 as it flows along flow-augmented surface 106 causes the total pressure of buffering fluid stream 302 to increase as it flows along flow-augmented surface 106. In some such examples, the total pressure of buffering fluid stream 302 at inlet 204, or the total pressure of the portion of buffering fluid stream 302 that flows into inlet 204, is greater than the total pressure of buffering fluid stream 302 as exhausted from outlet 206. In other words, positioning inlet 204 immediately downstream of flow-augmented surface 106 may contribute to establishing the desired pressure differential between inlet 204 and outlet 206 under operative conditions.

With continued reference to FIGS. 4 and 5, in some examples, fluid-dynamic exterior 102 comprises an upstream fluid-dynamic surface 110 directly adjacent to, and in upstream direction 306 of, outlet 206. In such examples, outlet 206 separates upstream fluid-dynamic surface 110 from flow-augmented surface 106. Flow-augmented surface 106 and upstream fluid-dynamic surface 110 each comprise an outlet-adjacent region 114 that extends adjacent to, and terminates along outlet 206. In this way, outlet 206 is at least partially defined between two outlet-adjacent regions 114. In some examples, outlet-adjacent region 114 of upstream fluid-dynamic surface 110 extends exterior of outlet-adjacent region 114 of flow-augmented surface 106 such that upstream fluid-dynamic surface 110 is configured to guide bulk fluid stream 300 over outlet 206, and outlet 206 is conformed to guide buffering fluid stream 304 to flow between bulk fluid stream 300 and flow-augmented surface 106. In some examples, such a conformation reduces the outlet total pressure under operative conditions relative to a conformation in which outlet-adjacent regions 114 of upstream fluid-dynamic surface 110 and flow-augmented surface 106 are aligned with one another and/or a configuration in which outlet-adjacent region 114 of upstream fluid-dynamic surface 110 extends interior of outlet-adjacent region 114 of upstream fluid-dynamic surface 110. In other words, such a conformation of outlet 206 also may aid in establishing the total pressure differential between inlet 204 and outlet 206.

More specifically, fluid-dynamic exterior 102 defines a normal axis 312 that extends perpendicular to fluid-dynamic exterior 102 and positively towards exterior region 310. As defined herein, one surface extending “exterior of” another surface refers to the one surface being positioned positively of the other surface along normal axis 312 of fluid-dynamic exterior 102 taken at a selected location of fluid-dynamic exterior 102. For the same reason, the other surface may be defined herein as extending “interior of” the one first surface. Thus, stating the above in slightly different terms, outlet-adjacent region 114 of upstream fluid-dynamic surface 110 is positioned positively of outlet-adjacent region 114 of flow-augmented surface 106 along normal axis 312 of fluid-dynamic exterior 102 taken at flow-augmented surface 106.

In some examples, fluid-dynamic exterior 102 comprises a downstream fluid-dynamic surface 112 positioned directly adjacent to, and in downstream direction 308 of inlet 204, such that inlet 204 extends between and separates downstream fluid-dynamic surface 112 and flow-augmented surface 106. In such examples, downstream fluid-dynamic surface 112 and flow-augmented surface 106 each comprise an inlet-adjacent region 116. In some examples, inlet-adjacent region 116 of downstream fluid-dynamic surface 112 extends exterior of inlet-adjacent region 116 of flow-augmented surface 106 such that inlet 204 is conformed to draw buffering fluid stream 304 from flow-augmented surface 106.

In some examples, the entirety of flow-augmented surface 106 extends interior of outlet-adjacent region 114 of upstream fluid-dynamic surface 110 and/or interior of inlet-adjacent region 116 of downstream fluid-dynamic surface 112. Stated differently, flow-augmented surface 106 may be described as being sunken relative to adjacent regions of fluid-dynamic exterior 102. In some examples, this configuration assists in channeling buffering fluid stream 304 to flow along flow-augmented surface 106 and/or to fluidly partition flow-augmented surface 106 from bulk fluid stream 300 along a greater portion of length 108 of flow-augmented surface 106.

Passive drag reduction system 200 may comprise any suitable structure and/or combination of walls and surfaces that define flow-repositioning duct 202, inlet 204, and/or outlet 206. In some examples, passive drag reduction system 200 comprises a pair of duct surfaces 208 that extend spaced apart from one another and between which flow-repositioning duct 202, inlet 204, and/or outlet 206 are defined. In particular, duct surfaces 208 may be spaced apart from one another along normal axis 312. In some examples, duct surfaces 208 extend at least substantially parallel to one another along at least a portion of flow-repositioning duct 202.

As best seen in FIG. 5, in some examples, passive drag reduction system 200 further comprises a pair of lateral duct surfaces 222 that extend spaced apart from one another and between duct surfaces 208. In such examples, flow-repositioning duct 202, inlet 204, and outlet 206 also are defined between lateral duct surfaces 222. In some examples, lateral duct surfaces 222 extend transverse to duct surfaces 208 and/or at least substantially parallel to one another. In some examples, lateral duct surfaces 222 are spaced apart from one another along width 109 of flow-augmented surface 106.

In some examples, duct surfaces 208 and lateral duct surfaces 222 form a tubular enclosure that defines flow-repositioning duct 202, inlet 204, and outlet 206. For simplicity, passive drag reduction system 200 is described in these examples as comprising four surfaces that collectively define flow-repositioning duct 202, inlet 204, and outlet 206. That said, duct surfaces 208 and/or lateral duct surfaces 222, or at least a portion thereof, additionally or alternatively may be contiguous, form a single surface and/or form a pair of shaped and intersecting surfaces that likewise define(s) flow-repositioning duct 202, inlet 204, and outlet 206.

In some examples, flow-repositioning duct 202 defines a duct thickness 220 that is measured between duct surfaces 208. In some examples, duct thickness 220 and/or a cross-sectional area of flow-repositioning duct 202 along a central region 218 of flow-repositioning duct 202 is greater than duct thickness 220 and/or the cross-sectional area of flow-repositioning duct 202 along outlet 206 and optionally inlet 204. In some examples, such a conformation of flow-repositioning duct 202 permits flow-repositioning duct 202 to passively draw, reposition, and/or exhaust captured fluid stream 302 under the operative conditions.

Duct thickness 220 and/or the cross-sectional area of flow-repositioning duct 202 along inlet 204 may be the same as or different from the cross-sectional area of flow-repositioning duct 202 along outlet 206. In some such examples, a difference in duct thickness 220 and/or the cross sectional area of flow-repositioning duct 202 along inlet 204 and outlet 206 respectively conforms inlet 204 and outlet 206 such that the inlet total pressure established at inlet 204 is greater than the outlet total pressure established at outlet 206 under operative conditions. As a specific example, duct thickness 220 and/or the cross-sectional area of flow-repositioning duct 202 along inlet 204 may be a threshold fraction of duct thickness 220 and/or the cross-sectional area of flow-repositioning duct 202 along inlet 204. Suitable examples of this threshold fraction comprise at least 25%, at least 50%, at least 75%, at least 100%, at least 150%, at least 200%, at least 250%, at least 300%, at least 350%, at least 400%, at most 50%, at most 75%, at most 100%, at most 150%, at most 200%, at most 250%, at most 300%, at most 350%, at most 400%, and/or at most 450%.

In some examples, duct thickness 220 along outlet 206 is selected to produce buffering fluid stream 304 with a selected buffering fluid stream thickness, at least immediately downstream of outlet 206. In some examples, duct thickness 220 along outlet 206 is selected such that the buffering fluid stream thickness is greater than a boundary layer thickness of the boundary layer of surface band 301, for example, as measured directly adjacent to, and in upstream direction 306 of, outlet 206. As defined herein, the buffering fluid stream thickness and the boundary layer thickness each are measured normal to fluid-dynamic exterior 102. In some examples, duct thickness 220 along outlet 206 is selected such that the buffering fluid stream thickness is at least 100%, at least 200%, at least 300%, at least 400%, at least 500%, at least 600%, at most 400%, at most 500%, at most 600%, at most 700%, at most 800%, at most 900%, at most 1000%, and/or at most 3000% of the boundary layer thickness.

In some examples, duct surfaces 208, at least in part, conform inlet 204 to passively direct captured fluid stream 302 into flow-repositioning duct 202. In some examples, duct surfaces 208 are shaped along inlet 204 to extend at least partially along upstream direction 306. As referred to herein, one or more elements extending “at least partially along” a particular direction (e.g. upstream direction 306) means that the one or more elements extend along a direction that comprises a component in the particular direction. In this way, inlet 204 may be conformed to direct buffering fluid stream 304 and/or bulk fluid stream 300 flowing in downstream direction 308 into flow-repositioning duct 202 and towards upstream direction 306. In some examples, duct surfaces 208, at least in part, conform outlet 206 to passively direct buffering fluid stream 304 to flow along flow-augmented surface 106. In some such examples, duct surfaces 208 are shaped along outlet 206 to extend at least partially in downstream direction 308. In some examples, duct surfaces 208 curve towards downstream direction 308 along outlet 206 and/or curve towards upstream direction 306 along inlet 204.

Duct surfaces 208 may be described as having a first duct surface 210 and a second duct surface 212, where second duct surface 212 is spaced in downstream direction 308 of first duct surface 210 along inlet 204, and second duct surface 212 is spaced in upstream direction 306 of first duct surface 210 along outlet 206. In some examples, second duct surface 212 intersects upstream fluid-dynamic surface 110 and downstream fluid-dynamic surface 112, while second duct surface 212 is spaced apart from upstream fluid-dynamic surface 110 and downstream fluid-dynamic surface 112.

As perhaps best seen in FIG. 4, in some examples, second duct surface 212 extends exterior of first duct surface 210 and/or flow-augmented surface 106 along inlet 204. In some examples, this conformation of duct surfaces 208 increases the inlet total pressure established at inlet 204 under operative conditions, for example, by creating ram pressure at second duct surface 212. In some such examples, second duct surface 212 extends over and spaced apart from and/or overlaps inlet-adjacent region 116 of flow-augmented surface 106. In some examples, such a conformation of duct surfaces 208 conforms inlet 204 to capture at least a portion of buffering fluid stream 304 from flow-augmented surface 106.

In some examples, second duct surface 212 extends exterior of the first duct surface 210 along outlet 206. In some such examples, second duct surface 212 extends over and spaced apart from and/or overlaps outlet-adjacent region 114 of flow-augmented surface 106. In some examples, such a conformation of duct surfaces 208 conforms outlet 206 to guide buffering fluid stream 304 to flow along flow-augmented surface 106 and/or between flow-augmented surface 106 and bulk fluid stream 300.

In some examples, passive drag reduction system 200 comprises one or more flow-augmenting features disposed along fluid-dynamic exterior 102 that are configured to facilitate, enhance, and/or increase the desired static pressure differential between inlet 204 and outlet 206 under the operative conditions. Examples of flow-augmenting features comprise a protrusion or a cavity applied upstream of inlet 204 along flow-augmented surface 106, along inlet-adjacent region 116 of fluid-dynamic surface 106, and/or downstream of inlet 204 along downstream fluid-dynamic exterior 112. Additional examples of flow-augmenting features comprise a protrusion or a cavity applied upstream of outlet 206 along upstream fluid-dynamic surface 110, downstream of outlet 206 along flow-augmented surface 106, and/or along outlet-adjacent region 114 of flow-augmented surface 106.

In a more specific example, passive drag reduction system 200 comprises a flow protrusion 214 that is disposed along flow-augmented surface 106 adjacent to inlet 204 and configured to increase the inlet static pressure established at inlet 204 under operative conditions. In some examples, flow protrusion 214 comprises a rounded ridge that runs parallel to, and along, the width 109 of flow-augmented surface 106. In some examples, flow protrusion 214 is positioned along flow-augmented surface 106 at a separation from inlet 204 that is a threshold fraction of the length 108 of flow-augmented surface 106. As examples, the threshold fraction of this separation to the length 108 of flow-augmented surface 106 may be at least 1%, at least 2%, at least 3%, at least 4%, at least 5%, at least 6%, at least 7%, at least 8%, at least 9%, at least 10%, at least 15%, at least 20%, at most 1%, at most 2%, at most 3%, at most 4%, at most 5%, at most 6%, at most 7%, at most 8%, at most 9%, at most 10%, at most 15%, at most 20%, and/or at most 25%.

As mentioned, flow-repositioning duct 202 comprises a central region 218 that extends between inlet 204 and outlet 206. In some examples, passive drag reduction system 200 comprises a flow hood 118 that comprises flow-augmented surface 106 and first duct surface 210 and that separates, or interposes, central region 218 of flow-repositioning duct 202 from exterior region 310. In some such examples, flow hood 118 forms a closed shape and/or volume, with flow-augmented surface 106 and first duct surface 210 extending spaced apart from one another along central region 218 of flow-repositioning duct 202 and intersecting along inlet 204 and outlet 206. In some examples, passive drag reduction system 200 further comprises an interior wall 120 that comprises second duct surface 212 and a support structure 122 that supports flow hood 118 relative to interior wall 120. In particular, interior wall 120 separates flow-repositioning duct 202 from structural interior 104. Support structure 122 supports flow hood 118 relative to interior wall 120 such that duct surfaces 208 are spaced apart from one another and/or such that flow-augmented surface 106 is positioned in a desired manner relative to adjacent portions of fluid-dynamic exterior 102. In some examples, support structure 122 interconnects interior wall 120 and flow hood 118. As a more specific example, support structure 122 may comprise at least one, and optionally a plurality of, ribs that extend between interior wall 120 and flow hood 118 and generally are aligned with length 108 of flow-augmented surface 106. In some examples, lateral duct surfaces 222 are comprised in support structure 122.

As perhaps best seen in FIG. 4, in some examples, flow-repositioning duct 202 comprises more than one inlet 204 and/or more than one outlet 206. For example, fluid-dynamic structure 100 may comprise a first surface 152 and a second surface 154 spaced apart from first surface 152, where at least a portion of structural interior 104 is between first surface 152 and second surface 154. In such examples, bulk fluid stream 300 flows in downstream direction 308 along first surface 152 and second surface 154. In some examples, flow-repositioning duct 202 comprises a first outlet 206 that extends through first surface 152 and a second outlet 206 that extends through second surface 154. In such examples, both first surface 152 and second surface 154 comprise a respective flow-augmented surface 106 in downstream direction 308 of the respective outlet 206. In other words, each outlet 206 is configured to exhaust captured fluid stream 302 from flow-repositioning duct 202 onto the respective flow-augmented surface 106. In some examples, the first outlet 206 and the second outlet 206 are aligned with one another along the length of fluid-dynamic structure 100.

Additionally or alternatively, in some examples, flow-repositioning duct 202 comprises a first inlet 204 that extends through first surface 152 and a second inlet 204 that extends through second surface 154. In such examples, both the first inlet 204 and the second inlet 204 are configured to draw a respective portion of captured fluid stream 302 into flow-repositioning duct 202. In some examples, first inlet 204 and second inlet 204 are aligned with one another along the length of fluid-dynamic structure 100.

FIGS. 6-10 provide illustrative, non-exclusive examples of fluid-dynamic structures 100 in the form of airfoils 150. Where appropriate, the reference numerals from the schematic illustrations of FIGS. 4 and 5 are used to designate corresponding parts of airfoils 150 of FIGS. 6-10; however the examples of airfoils 150 provided in FIGS. 6-10 are non-exclusive and do not limit fluid-dynamic structures 100 to the examples of FIGS. 6-10. That is, fluid-dynamic structures 100 may incorporate any number of the various aspects, configurations, characteristics, properties, variants, options etc. of fluid-dynamic structures 100 that are illustrated in and discussed with reference to the schematic representation of FIGS. 4-5 and/or the embodiment of FIGS. 6-10, as well as variations thereof, without requiring the inclusion of all such aspects, configurations, characteristics, properties, variants, options etc. For the purpose of brevity, each previously discussed component, part, portion, aspect, region, etc. or variants thereof may not be discussed, illustrated, and/or labeled again with respect to the examples of FIGS. 6-10; however, it is within the scope of the present disclosure that the previously discussed features, variants, etc. may be utilized with the examples of FIGS. 6-10.

With initial reference to FIG. 6, illustrated therein is a schematic cross-sectional view showing examples in which fluid-dynamic structure 100 comprises an airfoil 150. As shown in FIG. 6, airfoil 150 comprises first surface 152, second surface 154 spaced apart from first surface 152, a leading edge 156, and a trailing edge 158. Leading edge 156 and trailing edge 158 each extend between first surface 152 and second surface 154. Trailing edge 158 is spaced apart from leading edge 156 by a chord length 160 of the airfoil 150, with leading edge 156 being positioned in upstream direction 306 from trailing edge 158. First surface 152, second surface 154, leading edge 156, and trailing edge 158 collectively encompass structural interior 104. Flow-repositioning duct 202 extends within structural interior 104 of airfoil 150, and outlet 206 extends through first surface 152 of airfoil 150. In this way, first surface 152 comprises flow-augmented surface 106. Under operative conditions, bulk fluid stream 300 may flow in downstream direction 308 along first surface 152 and second surface 154. In some examples, first surface 152 is an upper, or low-pressure, surface of airfoil 150, and second surface 154 is a lower, or high-pressure, surface of airfoil 150. In some examples, passive drag reduction system 200 further comprises interior wall 120 and/or flow hood 118 such as discussed herein with reference to FIG. 4.

In some examples, inlet 204 also extends through first surface 152. In some examples, inlet 204 and outlet 206 are spaced apart from one another along chord length 160, with flow-augmented surface 106 extending and/or being defined between inlet 204 and outlet 206. In some examples, outlet 206 is positioned closer to leading edge 156 than inlet 204. In some examples, inlet 204 and outlet 206 are positioned relative to chord length 160 such that the total pressure of bulk fluid stream 300 is greater along inlet 204 than along outlet 206.

In more specific examples, outlet 206 is positioned at a distance from leading edge 156 that is a threshold fraction of chord length 160, with examples of this threshold fraction including at least 0.5%, at least 1%, at least 5%, at least 10%, at least 20%, at least 30%, at least 40%, at least 50%, at least 60%, at least 70%, at least 80%, at least 85%, at most 5%, at most 10%, at most 20%, at most 30%, at most 40%, at most 50%, at most 60%, at most 70%, at most 80%, and/or at most 90%. Inlet 204 also may be positioned at a respective distance from leading edge 156 that is a threshold fraction of chord length 160. More specific examples of this threshold fraction comprise at least 4%, at least 5%, at least 10%, at least 20%, at least 30%, at least 40%, at least 50%, at least 60%, at least 70%, at least 80%, at least 85%, at least 90%, at least 95%, at most 5%, at most 10%, at most 20%, at most 30%, at most 40%, at most 50%, at most 60%, at most 70%, at most 80%, at most 90%, at most 95%, and/or at most 100%.

In some examples, inlet 204 and outlet 206 are disposed along first surface 152 such that the surface area of flow-augmented surface 106 represents a threshold fraction of a total surface area of first surface 152, which comprises a surface area of flow-augmented surface 106. As examples, inlet 204 and outlet 206 may be disposed along first surface 152 such that the threshold fraction of the surface area of flow-augmented surface 106 to the total surface area of first surface 152 is at least 1%, at least 5%, at least 10%, at least 20%, at least 30% at least 40%, at least 50%, at least 60%, at least 70%, at least 80%, at least 90%, at least 95%, at most 5%, at most 10%, at most 20%, at most 30%, at most 50%, at most 60%, at most 70%, at most 80%, at most 90%, at most 95%, and/or at most 99%.

In some examples, duct thickness 220 of flow-repositioning duct 202 is dimensioned relative to chord length 160. More specifically, in some examples, duct thickness 220 is dimensioned to be a threshold fraction of chord length 160, with examples of the threshold fraction of duct thickness 220 to chord length comprising at least 0.2%, at least 0.5%, at least 1%, at least 2%, at least 5%, at least 8%, at least 10%, at least 12%, at least 15%, at least 18%, at least 20%, at least 40%, at least 60%, at least 80%, at most 0.5%, at most 1%, at most 2%, at most 5%, at most 8%, at most 12%, at most 15%, at most 18%, at most 20%, at most 40%, at most 60%, at most 80%, and/or at most 100%.

As shown in FIG. 6, airfoil 150 defines an airfoil thickness 162 that is measured between first surface 152 and second surface 154. Airfoil thickness 162 varies along chord length 160 of airfoil 150, with airfoil thickness 162 generally being the largest along the center of chord length 160 and tapering towards leading edge 156 and trailing edge 158. In some examples, inlet 204 and outlet 206 are disposed along first surface 152 such that airfoil thickness 162 proximate outlet 206 is greater than airfoil thickness proximate inlet 204. In some examples, this positioning of inlet 204 and outlet 206 creates and/or contributes to the desired total pressure differential being established therebetween under the operative conditions. In other examples, inlet 204 and outlet 206 are positioned along first surface 152 such that airfoil thickness 162 proximate inlet 204 is greater than airfoil thickness 162 proximate outlet 206.

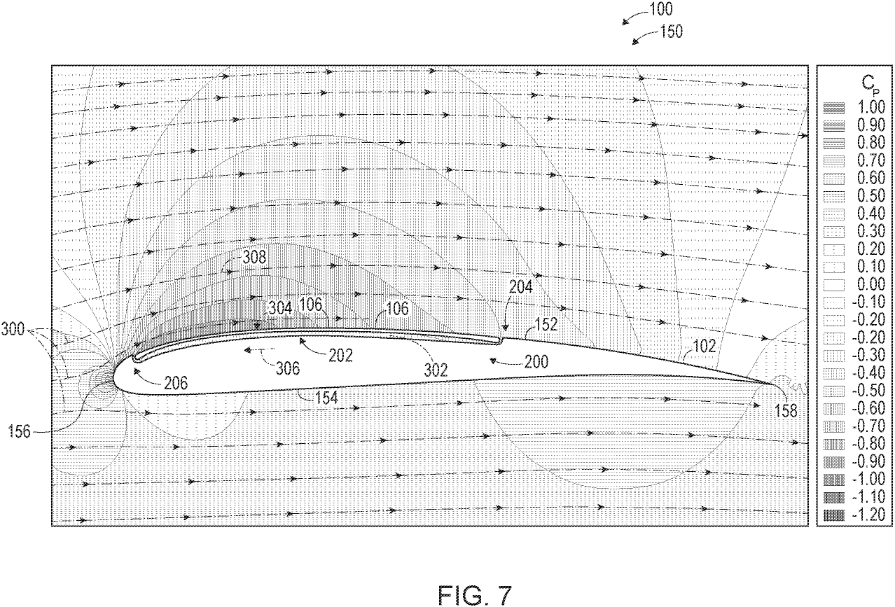

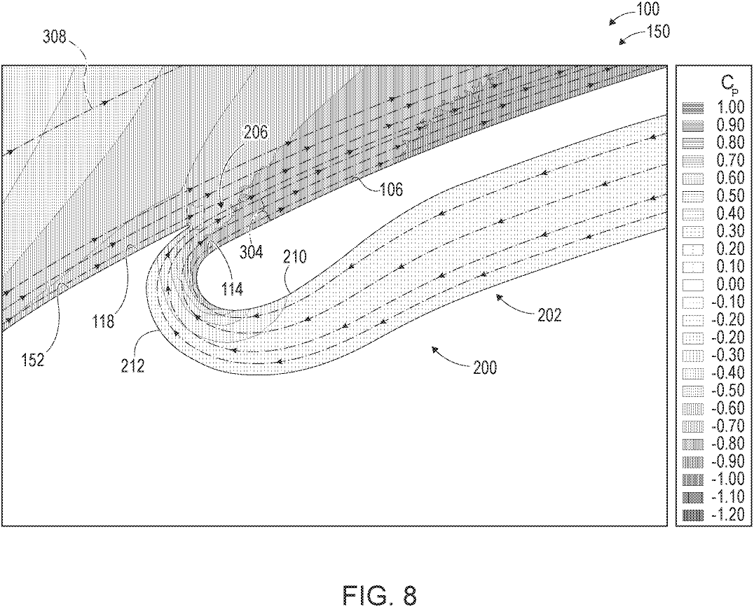

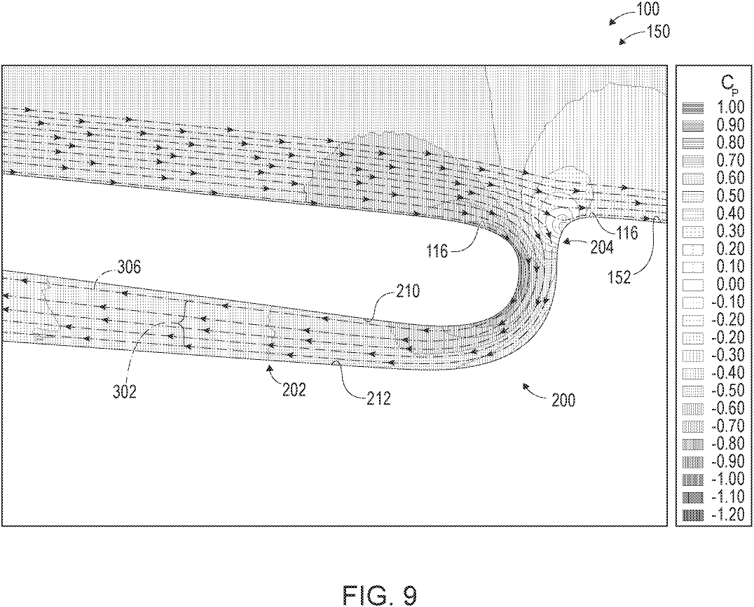

FIGS. 7-9 illustrate an example airfoil 150 under operative conditions according to the present disclosure. Specifically, FIG. 7 is a schematic cross-sectional view of the example airfoil 150 under operative conditions, FIG. 8 is a partial view showing outlet 206 of the example airfoil 150 under operative conditions, and FIG. 9 is a partial view showing inlet 204 of the example airfoil 150 of FIG. 7.

With reference to FIGS. 7-9, airfoil 150 comprises fluid-dynamic exterior 102 having first surface 152, second surface 154, leading edge 156, and trailing edge 158. In this example, airfoil 150 is an asymmetric airfoil, with first surface 152 being configured as a low-pressure surface and second surface 154 being configured as a high-pressure surface. Passive drag reduction system 200 is configured to reduce drag along first surface 152. Specifically, inlet 204 and outlet 206 of flow-repositioning duct 202 extend through first surface 152, with inlet 204 being positioned in downstream direction 308 of outlet 206 along first surface 152. Flow-augmented surface 106 is comprised in first surface 152 and extends between inlet 204 and outlet 206. Outlet 206 is positioned within 2-5% of chord length 160 of airfoil 150 from leading edge 156, inlet 204 is positioned within 55-65% of chord length 160 of airfoil 150 from leading edge 156, and length 108 of flow-augmented surface 106, as measured along chord length 160 of airfoil 150, is 50-60% of the chord length of airfoil 150.

Under the operative conditions shown, bulk fluid stream 300 flows generally in downstream direction 308 along fluid-dynamic exterior 102 of airfoil 150, and a pressure profile in bulk fluid stream 300 is established about fluid-dynamic exterior 102. This pressure profile is represented in FIGS. 7-9 as the pressure coefficient (“Cp”) of bulk fluid stream 300, with regions of greater and lesser Cp distinguished from one another by banded lines and corresponding hatching. Each of FIGS. 7-9 also provide a side bar indicating the Cp range corresponding to each hatching pattern. For the sake of illustration, FIGS. 7-9 show the pressure profile of bulk fluid stream 300 as comprising banded regions of different pressure. However, a person of ordinary skill in the art will recognize that, in reality, the pressure profile of bulk fluid stream 300 may be more accurately described as a continuum and the banded regions are utilized herein to more clearly illustrate the differences in Cp within bulk fluid stream 300.

At least in part due to the shape of airfoil 150, the Cp of bulk fluid stream 300 varies along the fluid-dynamic exterior 102 of airfoil 150. As perhaps best seen in FIG. 7, inlet 204 and outlet 206 are disposed along first surface 152 such that the Cp of bulk fluid stream 300 adjacent to, or along, inlet 204 is greater than the Cp of bulk fluid stream 300 adjacent to, or along, outlet 206. This difference in pressure established under operative conditions, at least in part, permits passive drag reduction system 200 to passively draw captured fluid stream 302 into inlet 204 and passively move captured fluid stream 302 in upstream direction 306 to outlet 206. As also in FIG. 7, the Cp of captured fluid stream 302 within flow-repositioning duct 202 is greater than the Cp of bulk fluid stream 300 adjacent to, or along, outlet 206. This difference in pressure, at least in part, permits passive drag reduction system 200 to passively exhaust captured fluid stream 302 through outlet 206 as buffering fluid stream 304.

As perhaps best seen in FIG. 8, first duct surface 210 and second duct surface 212 of flow-repositioning duct 202 curve towards downstream direction 308 along outlet 206 such that outlet 206 is conformed to guide buffering fluid stream 304 to flow in downstream direction 308 along flow-augmented surface 106. Passive drag reduction system 200 also is conformed such that outlet-adjacent region 114 of flow-augmented surface 106 extends interior of outlet-adjacent region 114 of the portion of first surface 152 that extends directly adjacent to, and in upstream direction 306 of, outlet 206. Additionally, second duct surface 212 extends exterior of, and overlaps, outlet-adjacent region 114 of flow-augmented surface 106. This conformation, at least in part, permits outlet 206 to guide buffering fluid stream 304 to flow between flow-augmented surface 106 and bulk fluid stream 300, at least along a portion of length 108 of flow-augmented surface 106.

Now with particular reference to FIG. 9, first duct surface 210 and second duct surface 212 of flow-repositioning duct 202 curve towards upstream direction 306 along inlet 204, such that inlet 204 is conformed to guide captured fluid stream 302 in upstream direction 306. Passive drag reduction system 200 is conformed such that inlet-adjacent region 116 of flow-augmented surface 106 extends interior of inlet-adjacent region 116 of the portion of first surface 152 that extends directly adjacent to, and in downstream direction 308 of, inlet 204. Additionally, second duct surface 212 extends exterior of inlet-adjacent region 116 of flow-augmented surface 106. This conformation of inlet 204 at least in part permits inlet 204 to draw buffering fluid stream 304 and/or a portion of bulk fluid stream 300 as captured fluid stream 302. In some examples, this conformation of inlet 204 increases the Cp of bulk fluid stream 300 and/or buffering fluid stream 304 along, or adjacent to inlet 204.

In the specific examples of FIGS. 7-9, bulk fluid stream 300 comprises air and/or may be referred to as a bulk airstream. Airfoil 150 is oriented at an angle of attack of 1.5 degrees and moving at an airspeed of Mach 0.4 at an altitude of 36,000 feet. That said, passive drag reduction system 200 may effectively reposition fluid flow and reduce drag along airfoil 150 under a broad range of operating conditions. For example, the airspeed and altitude of airfoil 150 may be reduced to Mach 0.2 and sea level, respectively, with little or no impact on the pressure profile of bulk fluid stream 300 about airfoil 150 and the operation of passive drag reduction system 200. Passive drag reduction system 200 also may be effective in reducing drag along airfoil 150 as discussed herein with airfoil 150 oriented within a broad range of angles of attack. For example, passive drag reduction system 200 may operate a similar, or at least substantially similar manner, to the examples of FIGS. 7-9 with airfoil 150 oriented with any angle of attack of in the range of -3 to 8 degrees.

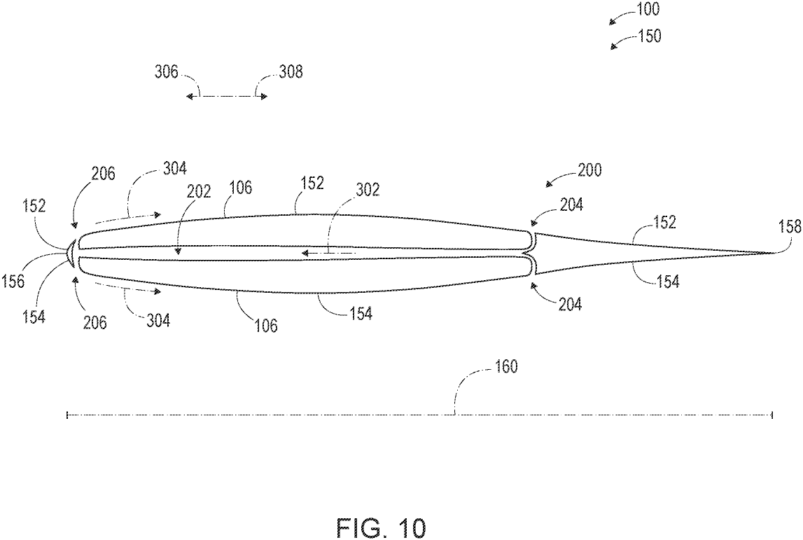

FIG. 10 is a schematic cross-sectional view illustrates another example airfoil 150 according to the present disclosure. As shown in FIG. 10, airfoil 150 comprises first surface 152, second surface 154, leading edge 156, and trailing edge 158, such as discussed herein. Airfoil 150 also comprises passive drag reduction system 200 having flow-repositioning duct 202. In this example, airfoil 150 comprises two inlets 204 and two outlets 206. Specifically, a first inlet 204 and a first outlet 206 extend through first surface 152 spaced apart from one another along chord length 160 of airfoil 150. Likewise, a second inlet 204 and a second outlet 206 extend through second surface 154 spaced apart from one another along chord length 160 of airfoil 150. Inlets 204 and outlets 206 are symmetrically disposed about airfoil 150 such that the first and second inlets 204 are aligned with one another along chord length 160 and such that the first and second outlets 206 are aligned with one another along chord length 160.

Inlets 204 are spaced in upstream direction 306 of trailing edge 158, with a portion of first surface 152 extending between the first inlet 204 and trailing edge 158 and a portion of the second surface 154 extending between the second inlet 204 and trailing edge 158. Similarly, outlets 206 are spaced in downstream direction 308 of leading edge 156, with a portion of first surface 152 extending between the first outlet 206 and first surface 152, and a portion of second surface 154 extending between the second outlet 206 and leading edge 156.

Under the operative conditions discussed herein, passive drag reduction system 200 is configured to passively direct captured fluid stream 302 into each inlet 204, through flow-repositioning duct 202, and exhaust captured fluid stream 302 out of each outlet 206 as buffering fluid stream 304, as discussed herein. Also under operative conditions, the inlet total pressure at each inlet 204 is less than the outlet total pressure at each outlet 206. The first outlet 206 is configured to direct buffering fluid stream 304 to flow along first surface 152, and the second outlet 206 is configured to direct buffering fluid stream 304 to flow along second surface 154. In this way, first surface 152 and second surface 154 each comprise a respective flow-augmented surface 106 that extends directly adjacent to, and in the downstream direction 308 of the respective outlet 206.

In this example, airfoil 150 is a symmetrical airfoil, such that the pressure and/or velocity profile of bulk fluid stream 300 along first surface 152 is similar to the pressure and/or velocity profile along second surface 154, at least under certain angles of attack. However, this is not required to all airfoils 150 having dual inlet 204 and/or dual outlet 206 configurations, and dual inlets 204 and/or dual outlet 206 configurations of flow-repositioning duct 202 additionally or alternatively may be implemented in asymmetrical airfoils without departing from the scope of the present disclosure.

The examples of airfoils 150 illustrated and discussed herein with reference to FIGS. 6-10 may be comprised in and/or utilized with any suitable type of airfoil. As examples, the examples of airfoils 150 of FIGS. 6-10 may be comprised in aircraft engine nacelles, such as engine nacelle 52 of FIG. 1, in aircraft flight control surfaces, such as any of flight control surfaces 60 of FIG. 1, in aircraft wings, such as aircraft wings 40 of FIG. 1, and/or in wind turbine rotor blades, such as rotor blades 86 of FIG. 3. As more examples, the examples of airfoils 150 of FIGS. 6-10 additionally or alternatively may be comprised in hydrofoils, vehicle spoilers, glider wings, and/or rocket stabilizers.

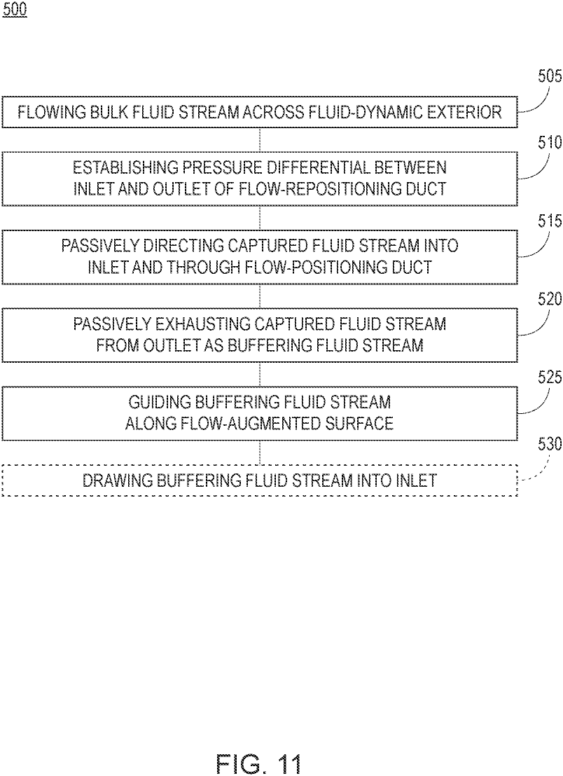

FIG. 11 provides a flowchart schematically representing examples of methods 500 of passively reducing drag on a fluid-dynamic structure with a passive drag reduction system according to the present disclosure. In FIG. 11, some steps are illustrated in dashed boxes, indicating that such steps may be optional or may correspond to an optional version of methods 500, according to the present disclosure. That said, not all methods according to the present disclosure are required to include the steps illustrated in solid boxes. The methods and steps of FIG. 11 are not limiting and other methods and steps are within the scope of the present disclosure, including methods having greater than or fewer than the number of steps illustrated, as understood from the discussion herein. Each step or portion of methods 500 may be performed utilizing fluid-dynamic structures 100 and/or passive drag reduction systems 200 and/or the features, functions, and/or portions thereof that are discussed in detail herein with respect to FIGS. 1-10. Likewise, any of the features, functions, and/or structures of fluid-dynamic structures 100 and/or passive drag reduction systems 200 discussed herein with reference to FIG. 11 may be included in and/or utilized in the examples of FIGS. 1-10 without departing from the scope of the present disclosure.

As shown in FIG. 11, methods 500 comprise flowing 505 a bulk fluid stream across a fluid-dynamic exterior of the fluid-dynamic structure , establishing 510 a pressure differential between an inlet and an outlet of a flow-repositioning duct, passively directing 515 a captured fluid stream into the inlet and through flow-repositioning duct, passively exhausting 520 the captured fluid stream as a buffering fluid stream at 520, and guiding 525 the buffering fluid stream along a flow-augmented surface at 525. In some examples, methods 500 comprise drawing 530 the buffering fluid stream.

The flowing 505 additionally or alternatively may be referred to herein as establishing the operative conditions at 505, such as discussed herein. In some examples, the flowing 505 comprises flowing the bulk fluid stream 300 over and/or relative to the inlet 204, the outlet 206, and/or the flow-augmented surface 106, such as discussed herein. Typically, the flowing 505 comprises flowing the bulk fluid stream 300 in the downstream direction 308 along fluid-dynamic exterior 102.

The flowing 505 is performed in any suitable manner that may vary based on the type of fluid-dynamic structure 100. For some examples in which the fluid-dynamic structure 100 is, or is comprised in, a vehicle (e.g. a land vehicle, a watercraft 90, and/or an aircraft 10), the flowing 505 comprises moving the vehicle within a range of velocities that is typical for the particular type of vehicle, which causes the bulk fluid stream 300 to flow over the fluid-dynamic exterior 102 of the vehicle. For some examples in which the fluid-dynamic structure 100 is comprised in an aircraft, such as aircraft 10 of FIG. 1, the flowing 505 comprises flying the aircraft 10 under cruising conditions, at a cruising altitude, and/or within a range of cruising velocities. For some examples in which the fluid-dynamic structure 100 is comprised in the hull of a watercraft, such as watercraft 90 of FIG. 2, the flowing 505 comprises submerging the passive drag reduction system 200 with the hull 92 in water and sailing the watercraft 90 at a cruising speed. For some examples in which the fluid-dynamic structure 100 is comprised in a rotor blade of a wind turbine, such as the wind turbines 80 of FIG. 3, the flowing 505 comprises permitting a wind-driven airstream to flow over the rotor blade 86.

Methods 500 also comprise establishing 510 a pressure differential between the inlet 204 and the outlet 206 of the flow-repositioning duct 202 of the passive drag reduction system 200 such that a total inlet pressure at the inlet 204 is greater than a total outlet pressure at the outlet 206. In some examples, the establishing 510 comprises establishing a static pressure differential between the inlet 204 and the outlet 206, such that an inlet static pressure at the inlet 204 is greater than an outlet static pressure at the outlet 206. Examples of the inlet 204, the outlet 206, and the flow-repositioning duct 202 are discussed herein. The establishing 510 is performed, responsive to, at least substantially simultaneously with, and/or during the flowing 505. The establishing 510 comprises passively establishing the pressure differential between the inlet 204 and the outlet 206. In other words, the establishing 510 is performed independently of, and/or without utilizing, an external power source. The establishing 510 also comprises driving the passively directing 515 and the passively exhausting 520. In other words, the establishing 510 comprises maintaining the pressure differential during the passively directing 515 and the passively exhausting 520 and/or to permit the passively directing 515 and the passively exhausting 520.

In some examples, the establishing 510 comprises flowing the bulk fluid stream 300 over the inlet 204 with a total pressure, and optionally a static pressure, greater than that with which the bulk fluid stream 300 flows over the outlet 206. In some examples, the establishing 510 comprises flowing a surface band 301 of the bulk fluid stream 300 at a greater velocity relative to and/or over the outlet 206 than the inlet 204. In some examples, the establishing 510 comprises shaping the bulk fluid stream 300 and/or shaping the flow path of the bulk fluid stream 300 to establish the pressure differential. In some such examples, the establishing 510 comprises flowing the bulk fluid-stream 300 over one or more flow-augmenting features disposed along fluid-dynamic exterior 102, such as discussed herein. In some examples, the establishing 510 is facilitated by the relative positions of inlet 204 and outlet 206 along fluid-dynamic exterior 102, such as discussed herein. In additional or alternative examples, the establishing 510 is facilitated by the relative conformations of inlet 204 and outlet 206, such as discussed herein.

As shown in FIG. 11, methods 500 further comprise passively directing 515 a captured fluid stream 302 into the inlet 204 and through the flow-positioning duct 202. The passively directing 515 additionally or alternatively may be described to as passively drawing the captured fluid stream 302 into the inlet 204 and driving the captured fluid stream 302 through the flow-repositioning duct 202 under the pressure differential established at 510. In some examples, the passively directing 515 comprises flowing the captured fluid stream 302 in an upstream direction 306, such as discussed herein.

The passively directing 515 comprises drawing the captured fluid stream 302 from one or more fluid streams that flow exterior of and/or over inlet 204. In some examples, the passively directing 515 comprises drawing at least a portion of the captured fluid stream 302 from the bulk fluid stream 300, and/or a surface band 301 thereof, such as discussed herein. In such examples, the passively directing 515 comprises repositioning a portion of the bulk fluid stream 300. Additionally or alternatively, in some examples, the passively directing 515 comprises drawing at least a portion of captured fluid stream 302 from the buffering fluid stream 304, such as discussed herein. In such examples, the passively directing 515 comprises recycling at least a portion of the buffering fluid stream 304. In some examples, the passively directing 515 comprises redirecting a portion of the bulk fluid stream 300 and/or a portion of the buffering fluid stream 304, such as with duct surfaces 208 discussed herein, to flow in upstream direction 306.

The passively directing 515 is performed with any suitable sequence or timing within methods 500, such as responsive to, or at least substantially simultaneously with the establishing 510 and/or prior to and/or at least substantially simultaneously with the passively exhausting 520.

Methods 500 further comprise passively exhausting 520 the captured fluid stream 302 through the outlet 206 as the buffering fluid stream 304. In some examples, the passively exhausting 520 is performed responsive to and/or substantially simultaneously with the passively directing 515 and/or the establishing 510. In some examples, the passively exhausting 520 comprises receiving, with the outlet 206, the captured fluid stream 302 from a central region 218 of the flow-repositioning duct 202, and exhausting the captured fluid stream 302 as the buffering fluid stream 304. In some examples, the passively exhausting 520 comprises redirecting the captured fluid stream 302, such as with duct surfaces 208 discussed herein, to flow in downstream direction 308. In some examples, the passively exhausting 520 comprises exhausting the buffering fluid stream 304 at a total pressure that is less than a total pressure of the captured fluid stream 302 along the inlet 204 and/or within a central region 218 of the flow-repositioning duct 202. In some examples, the passively exhausting 520 comprises passively exhausting the buffering fluid stream 304 at an average buffering fluid stream velocity that is less than an average surface band velocity of the surface band 301 that otherwise would flow along the flow-augmented surface 106 absent the buffering fluid stream 304 under the operative conditions, as discussed herein.

Methods 500 further comprise guiding 525 the buffering fluid stream 304, with the outlet 206, to flow along flow-augmented surface 106 of the fluid-dynamic exterior 102 and between the bulk fluid stream 300 and the flow-augmented surface 106. In some examples, the guiding 525 comprises fluidly partitioning the flow-augmented surface 106 from the bulk fluid stream 300 by flowing the buffering fluid stream 304 along the flow-augmented surface 106. In some examples, the guiding 525 comprises guiding, with the outlet 206, the buffering fluid stream 304 to flow in downstream direction 308 along the flow-augmented surface 106. In some examples, the guiding 525 comprises guiding the buffering fluid stream 304 to remain attached to the flow-augmented surface 106 along at least a portion of a length 108 of the flow-augmented surface 106, such as discussed herein.

In some examples, the guiding 525 comprises reducing viscous drag along the flow-augmented surface 106. In particular, in some examples, the guiding 525 comprises flowing the buffering fluid stream 304 along at least a portion of the length 108 of flow-augmented surface 106 at an average buffering fluid stream velocity that is less than an average surface band velocity of the surface band 301 that otherwise would flow along flow-augmented surface 106 absent buffering fluid stream 304 and/or passive drag reduction system 200, as discussed herein. In some examples, the guiding 525 comprises reducing a total viscous drag along fluid-dynamic exterior 102 relative to an otherwise equivalent fluid-dynamic structure 100 that does not comprise passive drag reduction system 200.

The guiding 525 is performed with any suitable sequence or timing within methods 500, such as responsive to and/or at least substantially simultaneously with the flowing 505, the establishing 510, the passively directing 515, and/or the passively exhausting 520. In some examples, the guiding 525 is performed prior to, and/or at least substantially simultaneously with the drawing 530.

As shown in FIG. 11, in some examples, methods 500 further comprise drawing 530 at least a portion of the buffering fluid stream 304 from the flow-augmented surface 106 into the inlet 204. In other words, the drawing 530 comprises drawing, by the inlet 204, at least a portion of the buffering fluid stream 304 that is exhausted by the outlet 206, such as discussed herein. Stated yet another way, the drawing 530 comprises forming a portion of the captured fluid stream 302 from the buffering fluid stream 304. Thus, the drawing 530 additionally or alternatively may be referred to as recycling the buffering fluid stream 304. When comprised in methods 500, the drawing 530 is performed simultaneously with, as a portion of, and/or comprises repeating, the passively directing 515.

Illustrative, non-exclusive examples of inventive subject matter according to the present disclosure are described in the following enumerated paragraphs:

A. A fluid-dynamic structure (100), comprising:
a fluid-dynamic exterior (102) that separates a structural interior (104) of the fluid-dynamic structure (100) from an exterior region (310) that is exterior to the fluid-dynamic structure (100), wherein the fluid-dynamic exterior (102) comprises a flow-augmented surface (106); and
a passive drag reduction system (200), comprising:
   a flow-repositioning duct (202) that extends within the structural interior (104) of the fluid-dynamic structure (100), wherein the flow-repositioning duct (202) comprises an inlet (204) and an outlet (206) that extend through the fluid-dynamic exterior (102) and that are spaced apart from one another along the fluid-dynamic exterior (102), wherein at least the outlet (206) is positioned directly adjacent to the flow-augmented surface (106);
wherein under operative conditions in which a bulk fluid stream (300) of fluid flows across the fluid-dynamic exterior (102), the passive drag reduction system (200) is configured to passively direct a captured fluid stream (302) into the inlet (204), through the flow-repositioning duct (202), and exhaust the captured fluid stream (302) through the outlet (206) as a buffering fluid stream (304), wherein the outlet (206) is configured to inject the buffering fluid stream (304) between the bulk fluid stream (300) and the flow-augmented surface (106) and direct the buffering fluid stream (304) to flow along the flow-augmented surface (106); and
wherein one or more of:
   the inlet (204) and the outlet (206) are conformed such that, under the operative conditions, an inlet total pressure established at the inlet (204) is greater than an outlet total pressure established at the outlet (206); or
   the inlet (204) and the outlet (206) are respectively positioned along the fluid-dynamic exterior (102) such that, under the operative conditions, the inlet total pressure established at the inlet (204) is greater than the outlet total pressure established at the outlet (206).

A1. The fluid-dynamic structure (100) of paragraph A, wherein, under the operative conditions, the buffering fluid stream (304) fluidly partitions the flow-augmented surface (106) from the bulk fluid stream (300) along at least a portion of a length (108) of the flow-augmented surface (106).

A2. The fluid-dynamic structure (100) of paragraph A1, wherein, under the operative conditions, the buffering fluid stream (304) reduces viscous drag along the flow-augmented surface (106).

A3. The fluid-dynamic structure (100) of any of paragraphs A-A2, wherein the outlet (206) is configured to guide the buffering fluid stream (304) to remain attached to the flow-augmented surface (106) along at least a portion of a/the length (108) of the flow-augmented surface (106).

A4. The fluid-dynamic structure (100) of paragraph A3, wherein the portion of the length (108) of the flow-augmented surface (106) is a threshold fraction of the length (108) of the flow-augmented surface (106), and wherein the threshold fraction is at least 20 percent (%), at least 30%, at least 40%, at least 50%, at least 60%, at least 70%, at least 80%, at least 85%, at least 90%, at most 50%, at most 60%, at most 70%, at most 80%, at most 85%, at most 90%, at most 95%, at most 99%, and/or at most 100%.

A5. The fluid-dynamic structure (100) of any of paragraphs A-A4, wherein the flow-augmented surface (106) defines a width (109) that is measured normal to a/the length (108) of the flow-augmented surface (106), wherein the outlet (206) extends along at least a substantial portion of the width (109) of the flow-augmented surface (106) and is configured to provide the buffering fluid stream (304) along at least the substantial portion of the width (109) of the flow-augmented surface (106).

A6. The fluid-dynamic structure (100) of any of paragraphs A-A5, wherein the outlet (206) is positioned in an upstream direction (306) of the flow-augmented surface (106).

A7. The fluid-dynamic structure (100) of paragraph A6, wherein the inlet (204) is positioned directly adjacent to and in a downstream direction (308) of the flow-augmented surface (106).

A8. The fluid-dynamic structure (100) of paragraph A7, wherein the flow-augmented surface (106) extends between the inlet (204) and the outlet (206).

A9. The fluid-dynamic structure (100) of any of paragraphs A7-A8, wherein under the operative conditions, the flow-repositioning duct (202) guides the captured fluid stream (302) at least partially along the upstream direction (306).

A10. The fluid-dynamic structure (100) of paragraph A9, wherein, under the operative conditions, the inlet (204) is configured to draw at least a portion of the buffering fluid stream (304) that is exhausted onto the flow-augmented surface (106) via the outlet (206).

A11. The fluid-dynamic structure (100) of paragraph A10, wherein, under the operative conditions, the inlet (204) is configured to draw a threshold fraction of the buffering fluid stream (304) that is exhausted onto the flow-augmented surface (106) by the outlet (206), and wherein the threshold fraction is between 0 and 30 %, at least 30%, at least 40%, at least 50%, at least 60%, at least 70%, at least 80%, at least 85%, at least 90%, at most 50%, at most 60%, at most 70%, at most 80%, at most 85%, at most 90%, at most 95%, at most 99%, and/or at most 100%.

A12. The fluid-dynamic structure (100) of any of paragraphs A6-A11, wherein the fluid-dynamic exterior (102) comprises an upstream fluid-dynamic surface (110) directly adjacent to, and in the upstream direction (306) of, the outlet (206), and wherein the outlet (206) extends between and separates the upstream fluid-dynamic surface (110) and the flow-augmented surface (106) from one another.

A13. The fluid-dynamic structure (100) of paragraph A12, wherein the flow-augmented surface (106) and an/the upstream fluid-dynamic surface (110) each comprise an outlet-adjacent region (114) that extends adjacent to and terminates along the outlet (206), and wherein the outlet-adjacent region (114) of the upstream fluid-dynamic surface (110) extends exterior of the outlet-adjacent region (114) of the flow-augmented surface (106) such that the upstream fluid-dynamic surface (110) is configured to guide the bulk fluid stream (300) to flow over the outlet (206), and the outlet (206) is conformed to guide the buffering fluid stream (304) to flow between the bulk fluid stream (300) and the flow-augmented surface (106).

A14. The fluid-dynamic structure (100) of any of paragraphs A7-A12, wherein the fluid-dynamic exterior (102) comprises a downstream fluid-dynamic surface (112) positioned directly adjacent to, and in the downstream direction (308) of, the inlet (204), and wherein the inlet (204) extends between and separates the downstream fluid-dynamic surface (112) from the flow-augmented surface (106).

A15. The fluid-dynamic structure (100) of paragraph A14, wherein the flow-augmented surface (106) and the downstream fluid-dynamic surface (112) each comprise an inlet-adjacent region (116) that extends adjacent to and terminates along, the inlet (204), and wherein the inlet-adjacent region (116) of the of the downstream fluid-dynamic surface (112) extends exterior of the inlet-adjacent region (116) of the flow-augmented surface (106) such that the inlet (204) is conformed to draw the buffering fluid stream (304) from the flow-augmented surface (106).

A16. The fluid-dynamic structure (100) of any of paragraphs A-A15, wherein the passive drag reduction system (200) comprises a pair of duct surfaces (208) that extend spaced apart from one another, and wherein the flow-repositioning duct (202) is defined between the duct surfaces (208).

A17. The fluid-dynamic structure (100) of paragraph A16, wherein the flow-repositioning duct (202) defines a duct thickness (220) that is measured between the duct surfaces (208), wherein the duct thickness (220) of the flow-repositioning duct (202) along the inlet (204) is a threshold fraction of the duct thickness (220) of the flow-repositioning duct (202) along the outlet (206), and wherein the threshold fraction of the duct thickness (220) of the flow-repositioning duct (202) along the inlet (204) to the duct thickness (220) of the flow-repositioning duct (202) at the outlet (206) is at least 25%, at least 50%, at least 75%, at least 100%, at least 150%, at least 200%, at least 250%, at least 300%, at least 350%, at least 400%, at most 50%, at most 75%, at most 100%, at most 150%, at most 200%, at most 250%, at most 300%, at most 350%, at most 400%, and/or at most 450%.

A18. The fluid-dynamic structure (100) of any of paragraphs A16-A17, wherein the duct surfaces (208) extend partially along an/the upstream direction (306) along the inlet (204).

A19. The fluid-dynamic structure (100) of paragraph A18, wherein the duct surfaces (208) curve towards a/the downstream direction (308) along the outlet (206).

A20. The fluid-dynamic structure (100) of any of paragraphs A16-A19, wherein the duct surfaces (208) extend partially along a/the downstream direction (308) along the outlet (206).

A21. The fluid-dynamic structure (100) of paragraph A20, wherein the duct surfaces (208) curve towards the upstream direction (306) along the inlet (204)

A22. The fluid-dynamic structure (100) of any of paragraphs A-A21, wherein the passive drag reduction system (200) comprises a flow protrusion (214) disposed along the flow-augmented surface (106) adjacent to the inlet (204) and configured to increase the inlet static pressure established at the inlet (204) under the operative conditions.

A23. The fluid-dynamic structure (100) of any of paragraphs A16-A22, wherein the flow-repositioning duct (202) comprises a central region (218) that extends between the inlet (204) and the outlet (206), wherein the passive drag reduction system (200) further comprises a flow hood (118) that comprises the flow-augmented surface (106) and that separates the central region (218) of the flow-repositioning duct (202) from the exterior region (310), and wherein the flow hood (118) further comprises a first duct surface (210) of the duct surfaces (208).

A24. The fluid-dynamic structure (100) of paragraph A23, wherein the passive drag reduction system (200) further comprises:
an interior wall (120) that comprises a second duct surface (212) of the duct surfaces (208); and
a support structure (122) that interconnects the flow hood (118) and the interior wall (120) and supports the flow hood (118) relative to the interior wall (120) such that the duct surfaces (208) are spaced apart from one another.

A25. The fluid-dynamic structure (100) of any of paragraphs A-A24, wherein the fluid-dynamic structure (100) comprises an airfoil (150), wherein the fluid-dynamic exterior (102) of the airfoil (150) comprises:
a first surface (152);
a second surface (154) opposed to and spaced apart from the first surface (152);
a leading edge (156) extending between the first surface (152) and the second surface (154);
a trailing edge (158) extending between the first surface (152) and the second surface (154) and spaced apart from the leading edge (156) by a chord length (160) of the airfoil (150);
wherein the structural interior (104) is defined between the first surface (152), the second surface (154), the leading edge (156), the trailing edge (158); and
wherein the flow-repositioning duct (202) extends within the structural interior (104) of the airfoil (150), wherein the outlet (206) extends through the first surface (152), and wherein the first surface (152) comprises the flow-augmented surface (106).

A26. The fluid-dynamic structure (100) of paragraph A25, wherein the inlet (204) extends through the first surface (152), wherein the outlet (206) is positioned closer to the leading edge (156) than the inlet (204), wherein the inlet (204) and the outlet (206) are spaced apart from one another along the chord length (160) of the airfoil (150), and wherein the flow-augmented surface (106) is defined between the inlet (204) and the outlet (206).

A27. The fluid-dynamic structure (100) of any of paragraphs A25-A26, wherein the outlet (206) is disposed along the first surface (152) at a distance from the leading edge (158) that is a threshold fraction of the chord length (160) of the airfoil (150), wherein the threshold fraction is at least 0.5%, at least 1%, at least 5%, at least 10%, at least 20%, at least 30%, at least 40%, at least 50%, at least 60%, at least 70%, at least 80%, at least 85%, at most 5%, at most 10%, at most 20%, at most 30%, at most 40%, at most 50%, at most 60%, at most 70%, at most 80%, and/or at most 90%.

A28. The fluid-dynamic structure (100) of any of paragraphs A25-A27, wherein the inlet (204) is disposed along the first surface (152) at a distance from the leading edge (158) that is a threshold fraction of the chord length (160) of the airfoil (150), and wherein the threshold fraction is at least 4%, at least 5%, at least 10%, at least 20%, at least 30%, at least 40%, at least 50%, at least 60%, at least 70%, at least 80%, at least 85%, at least 90%, at least 95%, at most 5%, at most 10%, at most 20%, at most 30%, at most 40%, at most 50%, at most 60%, at most 70%, at most 80%, at most 90%, at most 95%, and/or at most 100%.

A29. The fluid-dynamic structure (100) of any of paragraphs A25-A28, wherein the flow-augmented surface (106) defines a surface area, wherein the first surface (152) defines a total surface area that comprises the surface area of the flow augmented surface (106), wherein the surface area of the flow-augmented surface (106) is a threshold fraction of the total surface area of the first surface (152), and wherein the threshold fraction of the surface area of the flow-augmented surface (106) to the total surface area of the first surface (152) is at least 1%, at least 5%, at least 10%, at least 20%, at least 30% at least 40%, at least 50%, at least 60%, at least 70%, at least 80%, at least 90%, least 95%, at most 5%, at most 10%, at most 20%, at most 30%, at most 50%, at most 60%, at most 70%, at most 80%, at most 90%, most 95%, and/or at most 99%.

A30. The fluid-dynamic structure (100) of any of paragraphs A25-A29, wherein, under the operative conditions, a total pressure of the bulk fluid stream (300) varies along the first surface (152) with respect to the chord length (160) of the airfoil (150), and wherein the total pressure of the bulk fluid stream (300) proximate the inlet (204) is greater than the total pressure of the bulk fluid stream (300) proximate the outlet (206).

A31. The fluid-dynamic structure (100) of any of paragraphs A25-A30, wherein the outlet (206) is a first outlet (206) and the flow-augmented surface (106) is a first flow-augmented surface (106), wherein the flow-repositioning duct (202) further comprises a second outlet (206) that extends through the second surface (154) of the airfoil (150), and wherein the fluid-dynamic structure (100) further comprises a second flow-augmented surface (106) comprised in the second surface (154) of the airfoil (150) and extending adjacent to and in a/the downstream direction (308) of the second outlet (206).

A32. The fluid-dynamic structure (100) of paragraph A31, wherein the first outlet (206) and the second outlet (206) are aligned with one another along the chord length (160) of the airfoil (150).

A33. The fluid-dynamic structure (100) of any of paragraphs A31-A32, wherein the inlet (204) is a first inlet (204) and wherein the flow-repositioning duct (202) further comprises a second inlet (204) that extends through the second surface (154) of the airfoil (150).

A34. The fluid-dynamic structure (100) of paragraph A33, wherein the first inlet (204) and the second inlet (204) are aligned with one another along the chord length (160) of the airfoil (150).

A35. The fluid-dynamic structure (100) of any of paragraphs A25-A34, wherein the first surface (152) is a low pressure surface and the second surface (154) is a high pressure surface.

A36. The fluid-dynamic structure (100) of any of paragraphs A25-A35, wherein the airfoil (150) is one of an engine nacelle (52), a flight control surface (60), and a wing (40).

A37. The fluid-dynamic structure (100) of any of paragraphs A25-A35, wherein the airfoil (150) is a rotor blade (86) of a wind turbine (80).

A38. The fluid-dynamic structure (100) of any of paragraphs A25-A37, wherein the flow-repositioning duct (202) defines a/the duct thickness (220) that is measured between a/the duct surfaces (208), and wherein the duct thickness (220) is a threshold fraction of the chord length (160) of the airfoil (150), and wherein the threshold fraction of the duct thickness (220) to the chord length (160) is at least 0.2%, at least 0.5%, at least 1%, at least 2%, at least 5%, at least 8%, at least 10%, at least 12%, at least 15%, at least 18%, at least 20%, at least 40%, at least 60%, at least 80%, at most 0.5%, at most 1%, at most 2%, at most 5%, at most 8%, at most 12%, at most 15%, at most 18%, and/or at most 20%, at most 40%, at most 60%, at most 80%, and/or at most 100%.

A39. The fluid-dynamic structure (100) of any of paragraphs A25-A38, wherein the airfoil (150) defines an airfoil thickness (162) that is measured between the first surface (152) and the second surface (154), and wherein the airfoil thickness (162) of the airfoil (150) proximate the outlet (206) is greater than the airfoil thickness (162) of the airfoil (150) proximate the inlet (204).

A40. The fluid-dynamic structure (100) of any of paragraphs A-A39, wherein the bulk fluid stream (300) comprises a surface band (301) that flows in an immediate vicinity of the fluid-dynamic exterior (102), and wherein the surface band (301) flows along the fluid-dynamic exterior (102) at an average surface band velocity.

A41. The fluid-dynamic structure (100) of paragraph A40, wherein the buffering fluid stream (304) flows along the flow-augmented surface (106) at an average buffering fluid stream velocity.

A42. The fluid-dynamic structure (100) of paragraph A41, wherein the average buffering fluid stream velocity directly adjacent to, and in a/the downstream direction (308) of the outlet (206) is less than the average surface band velocity of the surface band (301) directly adjacent to, and in a/the upstream direction (306) of, the outlet (206).

A43. The fluid-dynamic structure (100) of any of paragraphs A40-A42, wherein under the operative conditions, a total viscous drag along the fluid-dynamic exterior (102) of the fluid-dynamic structure (100) is less than the total viscous drag along the fluid-dynamic exterior (102) of an otherwise equivalent fluid-dynamic structure that does not comprise the passive drag reduction system (200).

A44. The fluid-dynamic structure (100) of any of paragraphs A40-A43, wherein under equivalent operative conditions, the average buffering fluid stream velocity of the buffering fluid stream (304) along the flow-augmented surface (106) is less than the average surface band velocity of the surface band (301) along a region corresponding to the flow-augmented surface (106) of the fluid-dynamic exterior (102) of a/the otherwise equivalent fluid-dynamic structure.

B. An aircraft (10), comprising the fluid-dynamic structure (100) of any of paragraphs A-A44.

B1. The aircraft (10) of paragraph B1, wherein the aircraft comprises:
a fuselage (12);
one or more wings (40) operatively attached to and supported by the fuselage (12);
one or more engines (50), each being operatively attached to a wing (40) of the one or more wings (40);
an empennage (70);
a plurality of flight control surfaces (60) associated with one or more of the wings (40) and the empennage (70); and
wherein the passive drag reduction system (200) is comprised in one or more of the fuselage (12), the one or more wings (40), the one or more engines (50), the empennage (70), and one or more flight control surfaces (60) of the plurality of flight control surfaces (60).

B2. The aircraft of paragraph B1, wherein the aircraft (10) comprises a plurality of passive drag reduction systems (200), wherein each passive drag reduction system (200) is the passive drag reduction system (200) of any of paragraphs A-A44.

B3. A watercraft (90) comprising the fluid-dynamic structure (100) of any of paragraphs A-A44.

B4. The watercraft (90) of paragraph B3, wherein the passive drag reduction system (200) is disposed in a hull (92) of the watercraft (90).

B5. A wind turbine (80) comprising the fluid-dynamic structure (100) of any of paragraphs A-A44.

B6. The wind turbine (80) of paragraph B5, wherein the wind turbine (80) comprises a plurality of rotor blades (86), and wherein one of more rotor blades (86) of the plurality of rotor blades (86) comprise the airfoil (150) of any of paragraphs A25-A35.

C. A method (500) of passively reducing drag on a fluid-dynamic structure (100) with a passive drag reduction system (200), the method (500) comprising:
flowing (505) a bulk fluid stream (300) of fluid across a fluid-dynamic exterior (102) of the fluid-dynamic structure (100);
during the flowing, establishing (510) a pressure differential between an inlet (204) and an outlet (206) of a flow-repositioning duct (202) of the passive drag reduction system (200), wherein the flow-repositioning duct (202) extends within a structural interior (104) of the fluid-dynamic structure (100), wherein the inlet (204) and the outlet (206) extend through the fluid-dynamic exterior (102) and are spaced apart from one another along the fluid-dynamic exterior (102), and wherein the pressure differential is established such that an inlet total pressure at the inlet (204) is greater than an outlet total pressure at the outlet (206);
passively directing (515) a captured fluid stream (302) into the inlet (204) and through the flow-repositioning duct (202); and
passively exhausting (520) the captured fluid stream (302) through the outlet (206) as a buffering fluid stream (304);
guiding (525) the buffering fluid stream (304), with the outlet (206), to flow along a flow-augmented surface (106) of the fluid-dynamic exterior (102) and between the bulk fluid stream (300) and the flow-augmented surface (106); and
wherein the passively directing (515) and the passively exhausting (520) are driven by the pressure differential.

C1. The method of paragraph C, further comprising drawing (530) at least a portion of the buffering fluid stream (304) from the flow-augmented surface (106) and into the inlet (204).

C2. The methods of any of paragraphs C-C1, wherein the fluid-dynamic structure is the fluid-dynamic structure (100) of any of paragraphs A-A44.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the terms “selective” and “selectively,” when modifying an action, movement, configuration, or other activity of one or more components or characteristics of an apparatus, mean that the specific action, movement, configuration, or other activity is a direct or indirect result of one or more dynamic processes, as described herein. The terms “selective” and “selectively” thus may characterize an activity that is a direct or indirect result of user manipulation of an aspect of, or one or more components of, the apparatus, or may characterize a process that occurs automatically, such as via the mechanisms disclosed herein.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, an object that is at least substantially formed from a material includes an object for which at least 75% of the object is formed from the material and also includes an object that is completely formed from the material. As another example, a first direction that is at least substantially parallel to a second direction includes a first direction that forms an angle with respect to the second direction that is at most 22.5 degrees and also includes a first direction that is exactly parallel to the second direction. As another example, a first length that is substantially equal to a second length includes a first length that is at least 75% of the second length, a first length that is equal to the second length, and a first length that exceeds the second length such that the second length is at least 75% of the first length.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order, concurrently, and/or repeatedly.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A fluid-dynamic structure, comprising:
a fluid-dynamic exterior that separates a structural interior of the fluid-dynamic structure from an exterior region that is exterior to the fluid-dynamic structure, wherein the fluid-dynamic exterior comprises a flow-augmented surface; and
a passive drag reduction system, comprising:
a flow-repositioning duct that extends within the structural interior of the fluid-dynamic structure, wherein the flow-repositioning duct comprises an inlet and an outlet that extend through the fluid-dynamic exterior and that are spaced apart from one another along the fluid-dynamic exterior, wherein at least the outlet is positioned directly adjacent to the flow-augmented surface;
wherein under operative conditions in which a bulk fluid stream of fluid flows across the fluid-dynamic exterior, the passive drag reduction system is configured to passively direct a captured fluid stream into the inlet, through the flow-repositioning duct, and exhaust the captured fluid stream through the outlet as a buffering fluid stream, wherein the outlet is configured to inject the buffering fluid stream between the bulk fluid stream and the flow-augmented surface and direct the buffering fluid stream to flow along the flow-augmented surface; and
wherein one or more of:
the inlet and the outlet are conformed such that, under the operative conditions, an inlet total pressure established at the inlet is greater than an outlet total pressure established at the outlet; or
the inlet and the outlet are respectively positioned along the fluid-dynamic exterior such that, under the operative conditions, the inlet total pressure established at the inlet (204) is greater than the outlet total pressure established at the outlet.

2. The fluid-dynamic structure of claim 1, wherein, under the operative conditions, the buffering fluid stream fluidly partitions the flow-augmented surface from the bulk fluid stream along at least a portion of a length of the flow-augmented surface.

3. The fluid-dynamic structure of claim 2, wherein, under the operative conditions, the buffering fluid stream reduces viscous drag along the flow-augmented surface.

4. The fluid-dynamic structure of claim 1, wherein the outlet is positioned in an upstream direction of the flow-augmented surface, and wherein the inlet is positioned directly adjacent to and in a downstream direction of the flow-augmented surface.

5. The fluid-dynamic structure of claim 4, wherein under the operative conditions, the flow-repositioning duct guides the captured fluid stream at least partially along the upstream direction.

6. The fluid-dynamic structure of claim 4, wherein the flow-augmented surface extends between the inlet and the outlet.

7. The fluid-dynamic structure of claim 6, wherein, under the operative conditions, the inlet is configured to draw at least a portion of the buffering fluid stream that is exhausted onto the flow-augmented surface via the outlet.

8. The fluid-dynamic structure of claim 1, wherein the passive drag reduction system comprises a pair of duct surfaces that extend spaced apart from one another, and wherein the flow-repositioning duct is defined between the duct surfaces.

9. The fluid-dynamic structure of claim 8, wherein the duct surfaces extend partially along a downstream direction along the outlet.

10. The fluid-dynamic structure of claim 8, wherein the duct surfaces extend partially along an upstream direction along the inlet.

11. The fluid-dynamic structure of claim 8, wherein the flow-repositioning duct comprises a central region that extends between the inlet and the outlet, wherein the passive drag reduction system further comprises:
a flow hood that comprises the flow-augmented surface and that separates the central region of the flow-repositioning duct from the exterior region, wherein the flow hood further comprises a first duct surface of the duct surfaces;
an interior wall that comprises a second duct surface of the duct surfaces; and
a support structure that interconnects the flow hood and the interior wall and supports the flow hood relative to the interior wall such that the duct surfaces are spaced apart from one another.

12. The fluid-dynamic structure of claim 8, wherein the flow-repositioning duct defines a duct thickness that is measured between the duct surfaces, wherein the duct thickness of the flow-repositioning duct along the inlet is a threshold fraction of the duct thickness of the flow-repositioning duct along the outlet, and wherein the threshold fraction of the duct thickness of the flow-repositioning duct along the inlet to the duct thickness of the flow-repositioning duct along the outlet is at least 25% and at most 450%.

13. The fluid-dynamic structure of claim 1, wherein the fluid-dynamic structure comprises an airfoil, wherein the fluid-dynamic exterior of the airfoil comprises:
a first surface;
a second surface opposed to and spaced apart from the first surface;
a leading edge extending between the first surface and the second surface;
a trailing edge extending between the first surface and the second surface and spaced apart from the leading edge by a chord length of the airfoil;
wherein the structural interior is defined between the first surface, the second surface, the leading edge, the trailing edge; and
wherein the flow-repositioning duct extends within the structural interior of the airfoil, wherein the outlet extends through the first surface, and wherein the first surface comprises the flow-augmented surface.

14. The fluid-dynamic structure of claim 13, wherein the outlet is disposed along the first surface at a distance from the leading edge that is a threshold fraction of the chord length of the airfoil, wherein the threshold fraction is at least 0.5% and at most 90%.

15. The fluid-dynamic structure of claim 13, wherein the inlet is disposed along the first surface at a distance from the leading edge that is a threshold fraction of the chord length of the airfoil, and wherein the threshold fraction is at least 4% and at most 100%.

16. The fluid-dynamic structure of claim 13, wherein the first surface is a low pressure surface and the second surface is a high pressure surface.

17. The fluid-dynamic structure of claim 1, wherein the bulk fluid stream comprises a surface band that flows in an immediate vicinity of the fluid-dynamic exterior, wherein the surface band flows along the fluid-dynamic exterior at an average surface band velocity, wherein the buffering fluid stream flows along the flow-augmented surface at an average buffering fluid stream velocity, wherein under the operative conditions, the average buffering fluid stream velocity of the buffering fluid stream along the flow-augmented surface is less than the average surface band velocity of the surface band along a region corresponding to the flow-augmented surface of the fluid-dynamic exterior of an otherwise equivalent fluid-dynamic structure that does not comprise the passive drag reduction system.

18. An aircraft comprising the fluid-dynamic structure of claim 1.

19. The aircraft of claim 18, wherein the aircraft comprises:
a fuselage;
one or more wings operatively attached to and supported by the fuselage;
one or more engines, each being operatively attached to a wing of the one or more wings;
an empennage;
a plurality of flight control surfaces associated with one or more of the one or more wings and the empennage; and
wherein the passive drag reduction system is comprised in one or more of the fuselage, the one or more wings, the one or more engines, the empennage, and one or more flight control surfaces of the plurality of flight control surfaces.

20. A method of passively reducing drag on a fluid-dynamic structure with a passive drag reduction system, the method comprising:
flowing a bulk fluid stream of fluid across a fluid-dynamic exterior of the fluid-dynamic structure;
during the flowing, establishing a pressure differential between an inlet and an outlet of a flow-repositioning duct of the passive drag reduction system, wherein the flow-repositioning duct extends within a structural interior of the fluid-dynamic structure, wherein the inlet and the outlet extend through the fluid-dynamic exterior and are spaced apart from one another along the fluid-dynamic exterior, and wherein the pressure differential is established such that an inlet total pressure at the inlet is greater than an outlet total pressure at the outlet;
passively directing a captured fluid stream into the inlet and through the flow-repositioning duct; and
passively exhausting the captured fluid stream through outlet as a buffering fluid stream;
guiding the buffering fluid stream, with the outlet, to flow along a flow-augmented surface of the fluid-dynamic exterior and between the bulk fluid stream and the flow-augmented surface; and
wherein the passively directing and the passively exhausting are driven by the pressure differential.
